(19) United States
(12) Patent Application Publication
(10) Pub. No.: US 2025/0294384 A1
(43) Pub. Date: Sep. 18, 2025

(54) NETWORK TRANSITION BASED ON LINK QUALITY DISTRIBUTION INFORMATION

(71) Applicant: Charter Communications Operating, LLC, St. Louis, MO (US)

(72) Inventor: Pareshkumar Panchal, Highlands Ranch, CO (US)

(21) Appl. No.: 18/602,338

(22) Filed: Mar. 12, 2024

(51) Int. Cl. H04W 24/08; H04W 40/12

(52) U.S. Cl. CPC H04W 24/08; H04W 40/12

(57) ABSTRACT

A communication management resource receives first link quality metrics indicating wireless link quality provided by first wireless base stations in a first wireless network to first mobile communication devices. The communication management resource generates a first distribution function from the first link quality metrics. The communication management resource receives second link quality metrics indicating wireless link quality provided by second wireless base stations in the second wireless network to second mobile communication devices. The communication management resource generates a second distribution function from the second link quality metrics. Based on the first distribution function and the second distribution function, and threshold information, the communication management resource controls the connectivity of one or more mobile communication devices with respect to the first wireless network and the second wireless network.

### BACKGROUND

Conventional wireless technology has been used for many years to connect wireless devices such as phones, laptops, etc., to a landline network and other wireless networks. Today, such wireless networks support many different types of connection services such including but not limited to 4G/LTE or 5G, voice communications, cell communications, high-speed data services, Wi-Fi™ connectivity, and so on.

Cellular networks typically include a land area that has been divided into so-called cellular regions. A single base station typically resides in each cell. Often, the base station is connected to a landline network and supports communication with one or more wireless subscribers operating in a region covered by the cell. Accordingly, a wireless subscriber operating a cell phone in the cell is able to communicate with or have access to a landline network via a wireless link between the subscriber and a base station.

Conventional mobile communication devices can be configured to include multiple SIMs (Subscriber Identity Modules) to connect to different wireless networks. For example, a first SIM of the mobile communication device can be used to support wireless connectivity of the mobile communication device with the first wireless network; a second SIM of the mobile communication device can be used to support wireless connectivity of the mobile communication device with a second wireless network.

Depending on link quality associated with wireless services provided to the mobile communication device via the first wireless network and the second wireless network, the mobile communication device or other suitable entity can be configured to hand off a wireless connection from the first wireless network to the second wireless network or vice versa.

### BRIEF DESCRIPTION

In a so-called DSDS (Dual SIM Dual Stand By) network, devices are sometimes simultaneously connected to multiple wireless networks in a hybrid mobile network environment. However, wireless data transmission occurs only on one wireless network while the device is on standby for other network until a respective decision is made to switch from one network to another. Such decision-making parameters may be uniform across the network.

As a further example, wireless network operator A may be a so-called home operator while operator B may be a so-called visitor operator. Using improper decision-making parameters may impact several wireless network users due to the variable nature of RF (Radio Frequency) propagation including but not limited to coverage, interference, traffic patterns, applications being used by devices, timing of traffic at various locations, etc., associated with each of the operators. In many cases, conventional network transitions from one wireless network to another lead to poor network connectivity such as delays, lost connections, etc.

This disclosure includes the observation that it is desirable to consider transition types, success rates, and network transition causes. It is also desirable to understand that the network planning, deployment, frequency bands of both the operators can be different along with asynchronous network operations.

Multiple times, the decisions are made to switch over from operator A to operator B on generic value bases (flat value per network). In such an instance, however there are always good chances that the RF environment changes and the transition is not sustainable due to variations, hence, it is important to make a switch over decision by understanding the region environment rather than just specific location environment in terms of coverage, interference, loading etc. in

Techniques herein provide improved control of connecting a respective mobile communication device to a first wireless network of multiple different wireless networks during conditions in which the first wireless network provides good wireless service to the respective mobile communication device.

More specifically, a communication management resource as discussed herein controls wireless connectivity between a mobile communication device (a.k.a., user equipment) and multiple wireless networks. The communication management resource as discussed herein receives first link quality metrics indicating wireless link quality provided by first wireless base stations in a first wireless network to first mobile communication devices. The communication management resource generates a first distribution function from the first link quality metrics. The first distribution function provides an indication of link quality associated with the first wireless network providing wireless connections to the first communication devices. The communication management resource also generates threshold information associated with the first distribution function. The threshold information is used to control connectivity of a first mobile communication device with respect to the first wireless network and a second wireless network of second wireless base stations.

For example, the threshold information can be configured to include a first threshold value and a second threshold value. The first threshold value specifies a first threshold level (such as associated with an exit) of controlling the connectivity of the first mobile communication device with respect to the first wireless network and the second wireless network. The second threshold value (such as associated with entrance) specifies a second threshold level of controlling the connectivity of the first mobile communication device with respect to the first wireless network and the second wireless network.

In one example, the first threshold value indicates a first link quality level in which to control network transition (such as handoff, active session switchover, etc.) of an active communication session of the first mobile communication device from the first wireless network to the second wireless network; the second threshold value indicates a second link quality level in which to control network transition of the active communication session of the first mobile communication device from the second wireless network to the first wireless network.

As further discussed herein, assume that the first mobile communication device is connected to the first wireless network. The network transition of the first mobile communication device from the first wireless network to the second wireless network depends on a first link quality metric and a second link quality metric. The first link quality metric indicates a first wireless link quality of the first mobile communication device receiving first wireless communications from the first wireless network. Note that the first wireless link quality metric can be measured in any suitable resource. In one example, the first wireless link quality metric is measured by the first mobile communication device. The second link quality metric indicates a second wireless link quality of the first mobile communication device receiving second wireless communications from the second wireless network, the second wireless link quality metric measured by the first mobile communication device.

In accordance with a further example as discussed herein, the threshold information as previously discussed may include first threshold information. The communication management resource can be further configured to receive second link quality metrics indicating wireless link quality provided by second wireless base stations in the second wireless network to second mobile communication devices. The communication management resource can be configured to generate a second distribution function from the second link quality metrics.

Yet further, the threshold information can be configured to include includes a first threshold level and a second threshold level. The first threshold level can be configured to indicate a first link quality level in which to initiate network transitions from the first wireless network to the second wireless network with respect to the first content distribution function; the second threshold level can be configured to indicate a second link quality level in which to control network transitions from the second wireless network to the first wireless network.

Assume in this example that the communication management resource receives a first link quality metric indicating a link quality of a first mobile communication device receiving first wireless communications from the first wireless network. To determine whether to initiate a network transition from one wireless network to another, the communication management resource compares the first link quality metric to the first threshold level.

In a first instance, the communication management resource initiates a network transition of the first mobile communication device from the first wireless network to the second wireless network in response to detecting that the first link quality metric is greater than the first threshold level.

In a second instance, the communication management resource initiates a network transition of the first mobile communication device from the second wireless network to the first wireless network in response to detecting that the first link quality metric is less than the second threshold level.

In a third instance, the communication management resource prevents a network transition of the first mobile communication device from the first wireless network to the second wireless network in response to detecting that the first link quality metric is less than the second threshold level.

Yet further, note that the wireless link quality as indicated by the first link quality metrics may be generated in any suitable manner such as, in one example, based on feedback from each respective mobile communication device of the first mobile communication devices. The first link quality metrics may include: i) a wireless power level as measured by the respective mobile communication device receiving a first wireless signal from the first wireless network, and ii) a signal-to-noise ratio as measured by the respective mobile communication device receiving the second wireless signal from the wireless network.

Examples as discussed herein are useful over conventional techniques. For example, implementation of a communication management resource and corresponding operations as discussed herein bias a mobile communication device to connect to a first wireless network (such as a home network) rather than a second wireless network.

Note that any of the resources as discussed herein can include one or more computerized devices, mobile communication devices, sensors, servers, base stations, wireless communication equipment, communication management systems, controllers, workstations, user equipment, handheld or laptop computers, or the like to carry out and/or support any or all of the method operations disclosed herein. In other words, one or more computerized devices or processors can be programmed and/or configured to operate as explained herein to carry out the different embodiments as described herein.

Yet other embodiments herein include software programs to perform the steps and operations summarized above and disclosed in detail below. One such embodiment comprises a computer program product including a non-transitory computer-readable storage medium, computer readable hardware storage medium, etc., on which software instructions are encoded for subsequent execution. The instructions, when executed in a computerized device (hardware) having a processor, program and/or cause the processor (hardware) to perform the operations disclosed herein. Such arrangements are typically provided as software, code, instructions, and/or other data (e.g., data structures) arranged or encoded on a non-transitory computer readable storage medium such as an optical medium (e.g., CD-ROM), floppy disk, hard disk, memory stick, memory device, etc., or other medium such as firmware in one or more ROM, RAM, PROM, etc., or as an Application Specific Integrated Circuit (ASIC), etc. The software or firmware or other such configurations can be installed onto a computerized device to cause the computerized device to perform the techniques explained herein. Accordingly, embodiments herein are directed to a method, system, computer program product, etc., that supports operations as discussed herein.

One embodiment includes a computer readable storage medium and/or system having instructions stored thereon. The instructions, when executed by the computer processor hardware, cause the computer processor hardware (such as one or more co-located or disparately processor devices or hardware) to: receive first link quality metrics indicating wireless link quality provided by first wireless base stations in a first wireless network to first mobile communication devices; generate a first distribution function from the first link quality metrics; and generate threshold information associated with the first distribution function, the threshold information used to control connectivity of a first mobile communication device with respect to the first wireless network and a second wireless network of second wireless base stations.

The ordering of the steps above has been added for clarity sake. Note that any of the processing steps as discussed herein can be performed in any suitable order.

Other embodiments of the present disclosure include software programs and/or respective hardware to perform any of the method embodiment steps and operations summarized above and disclosed in detail below.

It is to be understood that the system, method, apparatus, instructions on computer readable storage media, etc., as discussed herein also can be embodied strictly as a software program, firmware, as a hybrid of software, hardware and/or firmware, or as hardware alone such as within a processor (hardware or software), or within an operating system or a within a software application.

As discussed herein, techniques herein are well suited for use in the field of providing improved wireless connectivity in a network environment. However, it should be noted that embodiments herein are not limited to use in such applications and that the techniques discussed herein are well suited for other applications as well.

Additionally, note that although each of the different features, techniques, configurations, etc., herein may be discussed in different places of this disclosure, it is intended, where suitable, that each of the concepts can optionally be executed independently of each other or in combination with each other. Accordingly, the one or more present inventions as described herein can be embodied and viewed in many different ways.

Also, note that this preliminary discussion of embodiments herein (BRIEF DESCRIPTION OF EMBODIMENTS) purposefully does not specify every embodiment and/or incrementally novel aspect of the present disclosure or claimed invention(s). Instead, this brief description only presents general embodiments and corresponding points of novelty over conventional techniques. For additional details and/or possible perspectives (permutations) of the invention(s), the reader is directed to the Detailed Description section (which is a summary of embodiments) and corresponding figures of the present disclosure as further discussed below.

### BRIEF DESCRIPTION OF THE DRAWINGS

FIG. 1 is an example diagram illustrating implementation of a communication management resource to monitor each of multiple wireless networks and control respective wireless connectivity of mobile communication devices as discussed herein.

FIG. 2 is an example diagram illustrating implementation of multiple communication devices implementing DSDS (Dual SIM Dual Stand By) connectivity with different wireless networks as discussed herein.

FIG. 3 is an example diagram illustrating an example network environment including multiple wireless networks providing network access as discussed herein.

FIG. 4 is an example diagram illustrating monitoring and management of a respective wireless network as discussed herein.

FIG. 5 is an example diagram illustrating a first link quality distribution function and a second link quality distribution function based on RSRP (Reference Signal Received Power) as discussed herein.

FIG. 6 is an example diagram illustrating a first link quality distribution function and a second and quality distribution function based on RSRQ (Reference Signal Received Power) as discussed herein.

FIG. 7 is an example diagram illustrating a first link quality distribution function and a second link quality distribution function based on SINR (Signal to Interference & Noise Ratio) as discussed herein.

FIG. 8 is an example diagram illustrating example computer hardware and software operable to execute operations as described herein.

FIG. 9 is an example diagram illustrating a method as described herein.

The foregoing and other objects, features, and advantages of the invention will be apparent from the following more particular description of preferred embodiments herein, as illustrated in the accompanying drawings in which like reference characters refer to the same parts throughout the different views. The drawings are not necessarily to scale, with emphasis instead being placed upon illustrating the embodiments, principles, concepts, etc.

### DETAILED DESCRIPTION

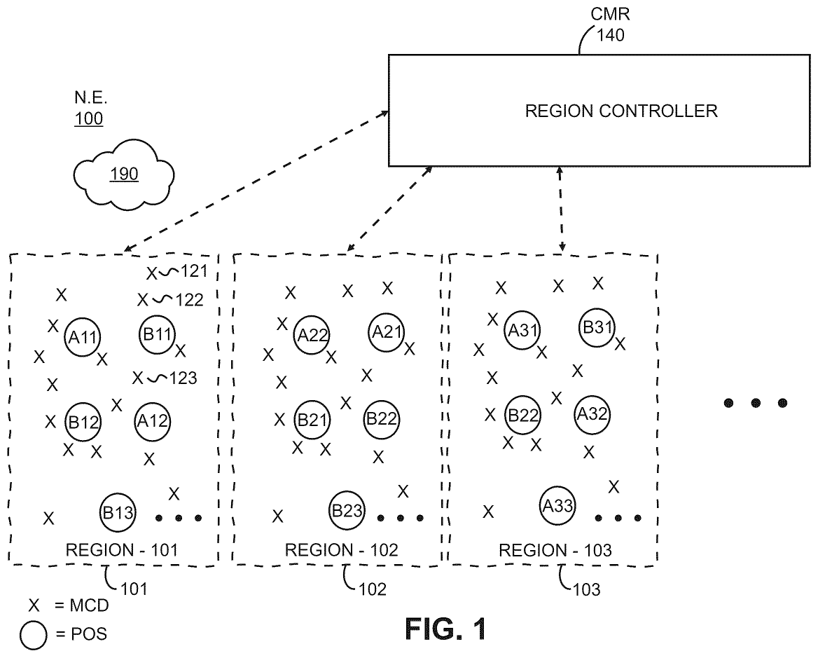

Now, more specifically, FIG. 1 is an example diagram illustrating implementation of an analyzer and configuration management system as discussed herein.

In this example, the network environment 100 includes communication management resource 140 as well as multiple regions of wireless coverage such as region of wireless coverage 101, region of wireless coverage 102, region of wireless coverage 103, etc.

Each region of wireless coverage includes multiple wireless base stations (a.k.a., gnodeB or other suitable entity) providing respective communication devices access to a respective network 190.

In one example, average RSRP (Coverage), RSRQ, and SINR thresholds associated with network transitions as discussed herein are determined by user throughput depending on the business requirement and terms with radio network chipset which relates to link curve. In below examples, thresholds are marked based on real network values. However, the values may vary depending on the frequency deployed.

In a CBRS (Citizen Band Radio System) network, there is a high probability of interference while being on GAA channel due to its nature of use (multiple operators may use same or adjacent frequency channel). In certain instances, one wireless network such as network A (such as wireless base stations A11, A12, etc.) may provide better wireless connectivity to a respective mobile communication device than a second wireless network such as network B (such as wireless base stations B11, B12, etc.).

There may be multiple different link quality parameters associated with the network environment 100 and corresponding regions of wireless coverage that indicate whether a corresponding wireless network supports good or bad wireless coverage.

In one example, as further discussed herein, the communication management resource 140 receives feedback from the mobile communication devices with respect to different link quality parameters such as RSRP (Coverage), RSRQ and SINR. For example, each of the symbols x in the network environment 100 indicate a corresponding mobile communication device in communication with one or more of the wireless networks A or B.

Note that the communication management resource 140 can be configured as communication management hardware, communication management software, or a combination of communication manager hardware and communication management software. The communication management resource 140 can be executed at any location in the respective network environment 100 such as at a centralized location, in each of the mobile communication devices, etc.

In region of wireless coverage 101, the network A includes wireless base station A11, wireless base station A12, etc., providing wireless connectivity to one or more mobile communication devices. Through the corresponding wireless base stations in network A, the communication devices have access to the network 190. In region of wireless coverage 101, the network B includes wireless base station B11, wireless base station B12, wireless base station B13, etc., providing one or more mobile communication devices wireless connectivity to one or more mobile communication devices. Through the corresponding wireless base stations in network B, the communication devices have access to the network 190.

In region of wireless coverage 102, the network A includes wireless base station A21, wireless base station A22, etc., providing wireless connectivity to one or more mobile communication devices. Through the corresponding wireless base stations in network A, the communication devices have access to the network 190. In region wireless coverage 112, the network B includes wireless base station B11, wireless base station B12, wireless base station B13, etc., providing one or more mobile communication devices wireless connectivity to one or more mobile communication devices. Through the corresponding wireless base stations in network B, the communication devices have access to the network 190.

In region of wireless coverage 103, the network A includes wireless base station A31, wireless base station A32, etc., providing wireless connectivity to one or more mobile communication devices. Through the corresponding wireless base stations in network A, the communication devices have access to the network 190. In region wireless coverage 113, the network B includes wireless base station B31, wireless base station B32, wireless base station B33, etc., providing one or more mobile communication devices wireless connectivity to one or more mobile communication devices. Through the corresponding wireless base stations in network B, the communication devices have access to the network 190.

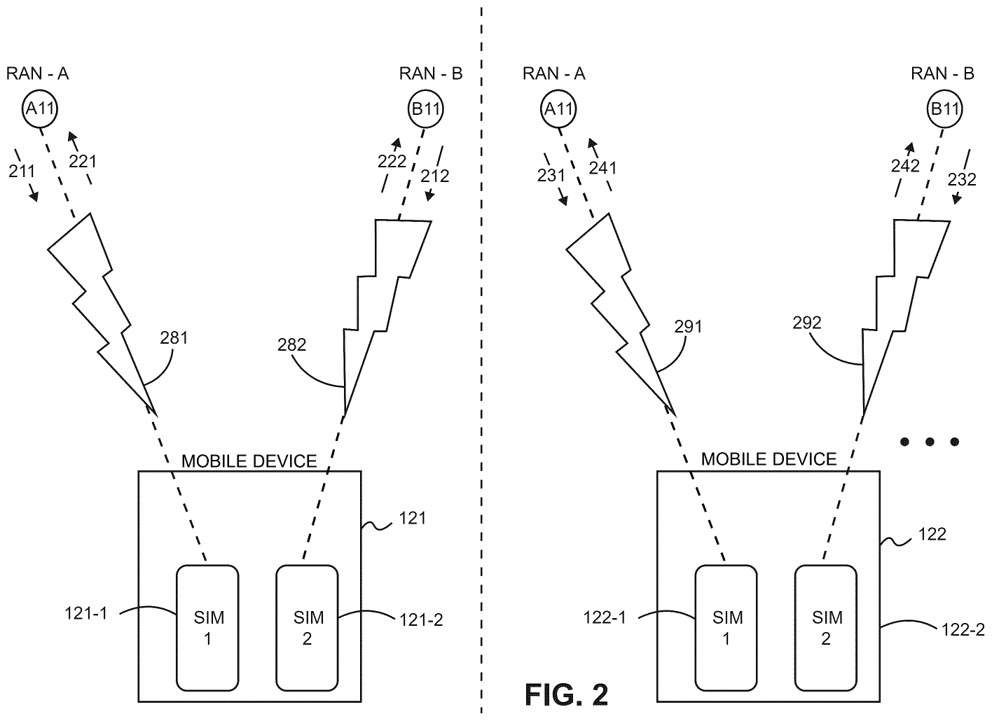

FIG. 2 is an example diagram illustrating implementation of multiple communication devices implementing DSDS (Dual SIM Dual Stand By) connectivity with different wireless networks as discussed herein.

In this example, each mobile communication device supports dual SIM operation enabling simultaneous wireless connectivity to wireless network 111 (such as any of wireless base stations A11, A12, . . . , A21, A22, . . . or RAN-A) and wireless network 112 (such as any of wireless base stations B11, B12, . . . , B21, A22, . . . or RAN-B). Each mobile communication device is on standby for one network in and is active on the other network.

In other words, as an example, the mobile communication device 121 is simultaneously connected to wireless base station A11 and wireless base station B11 while in the region of wireless coverage 101. The first wireless communication link between the mobile communication device 121 and the wireless base station A11 using the SIM 121-1 is active supporting a corresponding active session, meaning that the mobile communication device 121 is currently communicating with the remote network 190 through the wireless station A11. The mobile communication device 121 is in the standby mode (for example, not sending data packets to the wireless base station B11 to the remote network 190) via a second wireless communication link between the mobile communication device 121 and the wireless base station B11 using the SIM 121-2. As discussed herein, the communication management resource 140 can be configured to control whether the mobile communication device 121 is set to the active mode on wireless network 111 (corresponding to standby mode for wireless network 112) or active mode on wireless network 112 (corresponding to standby mode for wireless network 111).

The mobile communication device 122 is simultaneously connected to wireless base station A11 and wireless base station B11 while in the region of wireless coverage 101. The wireless communication link between the mobile communication device 122 and the wireless base station B11 using the SIM 122-2 is active, meaning that the mobile communication device 122 is currently communicating the inactive communication session with the remote network 190 through the wireless station B11. The mobile communication device 121 is in the standby mode (for example, not sending data packets to the wireless base station A11 to the remote network 190) via a wireless communication link between the mobile communication device 122 and the wireless base station A11 using the SIM 122-1. As discussed herein, the communication management resource 140 can be configured to control whether the mobile communication device 121 is set to the active mode on wireless network 111 (standby mode for wireless network 112) or active mode on wireless network 112 (standby mode for wireless network 111). In this example, the mobile communication device 121 uses the SIM 121-1 to support the wireless communication link 281 between the mobile communication device 121 and the wireless base station A11. The mobile communication device uses the SIM 121-2 to support the wireless communication link 282 between the mobile communication device 121 and the wireless base station B11. As previously discussed, one of the communication link 281 or wireless communication link 282 is active while the other communication link 281 or 282 is in standby mode.

Further in this example, the mobile communication device 121 uses the SIM 122-2 to support the wireless communication link 291 between the mobile communication device 121 and the wireless base station A11. The mobile communication device uses the SIM 122-2 to support the wireless communication link 292 between the mobile communication device 122 and the wireless base station B11. As previously discussed, one of the communication link 291 or wireless communication link 292 is active while the other communication link 291 or 292 is in standby mode.

In a similar manner, each of the mobile communication devices in the network environment 100 can be configured to operate in the same mode as mobile communication device 111 and mobile communication device 112.

As previously discussed, the communication management resource 140 can be configured to receive feedback from the mobile communication devices (operating in the dual SIM dual standby mode) with respect to different link quality parameters such as RSRP (Coverage), RSRQ and SINR. For example, each of the symbols X (representing corresponding communication devices) in the network environment 100 as shown in FIG. 2 indicate a corresponding mobile communication device in communication (each potentially operated in the dual SIM dual standby mode as previously discussed) with one or more of the wireless networks A or B.

As more specifically shown in FIG. 2, the mobile communication device 121 is configured with first subscriber identity information 121-1 (such as a first SIM) to establish first wireless connectivity and communicate with the first wireless network 111 and corresponding one or more wireless base stations Ax. The mobile communication device 121 is configured with first subscriber identity information 121-2 (such as a second SIM) to establish second wireless connectivity and communicate with the wireless network 112 and corresponding one or more wireless base stations Bx.

### Mobile Communication Device 121 Connected to Wireless Network 111

The mobile communication device 121 monitors one or more signals 211 received from the first wireless network 111 and any of its corresponding A base stations. For wireless network 111, the mobile communication device 121 can be configured to generate samples for link quality information such as RSRP. This may include the mobile communication device 121 receiving a respective reference signal transmitted by the wireless base station A11. In one example, the RSRP (LTE) or SS-RSRP (5G)-Reference Signal Received Power is measured by the mobile communication device is an RSSI type of measurement. More specifically, it is the power of the 4G/LTE Reference Signals spread over the full bandwidth and narrowband or the power of secondary sync block (SSB) signal in 5G. Thus, via a signal 211, the mobile communication device 121 can be configured to receive a respective reference signal generated by the wireless base station A11. The mobile communication device 121 generates a respective link quality metric indicating a power level of receiving that reference signal. Of course, the higher the power level of the mobile communication device 121 receiving the reference signal generated by the wireless base station A11, the better. Via communications 221, the mobile communication device 121 communicates samples of the corresponding link quality metric (RSRP) collected over time through the wireless base station A11 to the communication management resource 140.

As further shown, the mobile communication device 121 monitors one or more signals 211 received from the first wireless network 111 and any of its corresponding A base stations. For wireless network 111, the mobile communication device 121 generates samples for link quality information such as RSRQ (Reference Signal Received Quality). This may include the mobile communication device 121 receiving a respective reference signal transmitted by the wireless base station A11. In one example, the Reference Signal Received Quality (RSRQ) quantifies the quality of the received reference signal from the serving cell's base station A11. This Metric measures the signal quality; it may be defined as NxRSRP/RSSI where N is number of resource blocks, similar to Reference Signal Received Power (RSRP), but it can be configured to provide further assessment of the level of interference and noise in the received reference signal. Thus, via a signal 211, the mobile communication device 121 can be configured to receive a respective reference signal generated by the wireless base station A11. The mobile communication device 121 generates a respective link quality metric indicating a quality associated with receiving that reference signal. Of course, the higher the power quality of the mobile communication device 121 receiving the reference signal generated by the wireless base station A11, the better. Via communications 221, the mobile communication device 121 communicates samples of the corresponding link quality metric (RSRQ) collected over time through the wireless base station A11 to the communication management resource 140.

The mobile communication device 121 monitors one or more signals 211 received from the first wireless network 111 and any of its corresponding A base stations. For wireless network 111, the mobile communication device 121 generates samples for link quality information such as SINR (Signal Interference Noise Ratio). This may include the mobile communication device 121 receiving a respective signal transmitted by the wireless base station A11. In one example, the samples of SINR generated by the mobile communication device 121 measures signal quality such as the strength of the wanted signal compared to the unwanted interference and noise. Thus, via a signal 211, the mobile communication device 121 can be configured to receive a respective reference signal generated by the wireless base station A11. The mobile communication device 121 generates a respective SINR link quality metric indicating a quality associated with receiving that reference signal. Of course, the higher the signal quality of the mobile communication device 121 receiving the reference signal generated by the wireless base station A11, the better. Via communications 221, the mobile communication device 121 communicates samples of the corresponding SINR link quality metric collected over time through the wireless base station A11 to the communication management resource 140.

### Mobile Communication Device 121 Connected to Wireless Network 112

As previously discussed, the mobile communication device 121 is configured with second subscriber identity information 121-2 (such as a second SIM) to establish second wireless connectivity and communicate with the second wireless network 112 and corresponding base stations Bx.

The mobile communication device 121 (in standby mode for wireless network 112) monitors one or more signals 212 received from the second wireless network 112 and any of its corresponding B base stations. For wireless network 112, the mobile communication device 121 generates samples for link quality information such as RSRP. This may include the mobile communication device 121 receiving a respective reference signal transmitted by the wireless base station B11. In one example, the RSRP-Reference Signal Received Power is generated by the mobile communication device is an RSSI type of measurement. In one example, the RSRP (LTE) or SS-RSRP (5G)-Reference Signal Received Power is measured by the mobile communication device is an RSSI type of measurement. More specifically, it is the power of the 4G/LTE Reference Signals spread over the full bandwidth and narrowband or the power of secondary sync block (SSB) signal in 5G. Thus, via a signal 212, the mobile communication device 121 can be configured to receive a respective reference signal generated by the wireless base station B11. The mobile communication device 121 generates a respective link quality metric indicating a power level of receiving that reference signal. Of course, the higher the power level of the mobile communication device 121 receiving the reference signal generated by the wireless base station B11, the better. Via communications 222, the mobile communication device 121 communicates samples of the corresponding link quality metric (RSRP) collected over time through the wireless base station B11 to the communication management resource 140.

The mobile communication device 121 monitors one or more signals 212 received from the second wireless network 112 and any of its corresponding B base stations. For wireless network 112, the mobile communication device 121 generates samples for link quality information such as RSRQ (Reference Signal Received Quality). This may include the mobile communication device 121 receiving a respective reference signal transmitted by the wireless base station B11. In one example, the Reference Signal Received Quality (RSRQ) quantifies the quality of the received reference signal from the serving cell's base station B11. This metric measures the signal's strength, similar to Reference Signal Received Power (RSRP), but it can be configured to provide further assessment of the level of interference and noise in the received reference signal. Thus, via a signal 212, the mobile communication device 121 can be configured to receive a respective reference signal generated by the wireless base station B11. The mobile communication device 121 generates a respective link quality metric indicating a quality associated with receiving that reference signal. Of course, the higher the power quality of the mobile communication device 121 receiving the reference signal generated by the wireless base station B11, the better. Via communications 222, the mobile communication device 121 communicates samples of the corresponding link quality metric (RSRQ) collected over time through the wireless base station B11 to the communication management resource 140.

The mobile communication device 121 monitors one or more signals 212 received from the second wireless network 112 and any of its corresponding B base stations. For wireless network 112, the mobile communication device 121 generates samples for link quality information such as SINR (Signal Interference Noise Ratio). This may include the mobile communication device 121 receiving a respective signal transmitted by the wireless base station B11. In one example, the samples of SINR generated by the mobile communication device 121 measure signal quality: the strength of the wanted signal compared to the unwanted interference and noise. Thus, via a signal 212, the mobile communication device 121 can be configured to receive a respective reference signal generated by the wireless base station B11. The mobile communication device 121 generates a respective SINR link quality metric indicating a quality associated with receiving that reference signal. Of course, the higher the power quality of the mobile communication device 121 receiving the reference signal generated by the wireless base station B11, the better. Via communications 222, the mobile communication device 121 communicates samples of the corresponding SINR link quality metric collected over time through the wireless base station B11 to the communication management resource 140.

### Mobile Communication Device 122 Connected to Wireless Network 111

The mobile communication device 122 monitors one or more signals 231 received from the first wireless network 111 and any of its corresponding A base stations. For wireless network 111, the mobile communication device 122 generates samples for link quality information such as RSRP. This may include the mobile communication device 122 receiving a respective reference signal transmitted by the wireless base station A11. In one example, the RSRP (LTE) or SS-RSRP (5G)-Reference Signal Received Power is measured by the mobile communication device is an RSSI type of measurement. More specifically, it is the power of the 4G/LTE Reference Signals spread over the full bandwidth and narrowband or the power of secondary sync block (SSB) signal in 5G. Thus, via a signal 231, the mobile communication device 122 can be configured to receive a respective reference signal generated by the wireless base station A11. The mobile communication device 122 generates a respective link quality metric indicating a power level of receiving that reference signal. Of course, the higher the power level of the mobile communication device 122 receiving the reference signal generated by the wireless base station A11, the better. Via communications 241, the mobile communication device 122 communicates samples of the corresponding link quality metric (RSRP) collected over time through the wireless base station 11 to the communication management resource 140.

The mobile communication device 122 monitors one or more signals 231 received from the first wireless network 111 and any of its corresponding A base stations. For wireless network 111, the mobile communication device 122 generates samples for link quality information such as RSRQ (Reference Signal Received Quality). This may include the mobile communication device 122 receiving a respective reference signal transmitted by the wireless base station A11. In one example, the Reference Signal Received Quality (RSRQ) quantifies the quality of the received reference signal from the serving cell's base station A11. This metric measures the signal's strength, similar to Reference Signal Received Power (RSRP), but it can be configured to provide further assessment of the level of interference and noise in the received reference signal. Thus, via a signal 231, the mobile communication device 122 can be configured to receive a respective reference signal generated by the wireless base station A11. The mobile communication device 122 generates a respective link quality metric indicating a quality associated with receiving that reference signal. Of course, the higher the power quality of the mobile communication device 122 receiving the reference signal generated by the wireless base station A11, the better. Via communications 241, the mobile communication device 122 communicates samples of the corresponding link quality metric (RSRQ) collected over time through the wireless base station A11 to the communication management resource 140.

The mobile communication device 122 monitors one or more signals 231 received from the first wireless network 111 and any of its corresponding A base stations. For wireless network 111, the mobile communication device 122 generates samples for link quality information such as SINR (Signal Interference Noise Ratio). This may include the mobile communication device 122 receiving a respective signal transmitted by the wireless base station A11. In one example, the samples of SINR generated by the mobile communication device 122 measure signal quality: the strength of the wanted signal compared to the unwanted interference and noise. Thus, via a signal 231, the mobile communication device 122 can be configured to receive a respective reference signal generated by the wireless base station A11. The mobile communication device 122 generates a respective SINR link quality metric indicating a quality associated with receiving that reference signal. Of course, the higher the power quality of the mobile communication device 122 receiving the reference signal generated by the wireless base station A11, the better. Via communications 241, the mobile communication device 122 communicates samples of the corresponding SINR link quality metric collected over time through the wireless base station A11 to the communication management resource 140.

### Mobile Communication Device 122 Connected to Wireless Network 112

As previously discussed, the mobile communication device 122 is configured with second subscriber identity information 122-2 (such as a second SIM) to establish second wireless connectivity and communicate with the second wireless network 112 and corresponding base stations Bx.

The mobile communication device 122 (in standby mode for wireless network 112) monitors one or more signals 232 received from the second wireless network 112 and any of its corresponding B base stations. For wireless network 112, the mobile communication device 122 generates samples for link quality information such as RSRP. This may include the mobile communication device 122 receiving a respective reference signal transmitted by the wireless base station B11. In one example, the RSRP (LTE) or SS-RSRP (5G)-Reference Signal Received Power is measured by the mobile communication device is an RSSI type of measurement. More specifically, it is the power of the 4G/LTE Reference Signals spread over the full bandwidth and narrowband or the power of secondary sync block (SSB) signal in 5G. Thus, via a signal 232, the mobile communication device 122 can be configured to receive a respective reference signal generated by the wireless base station B11. The mobile communication device 122 generates a respective link quality metric indicating a power level of receiving that reference signal. Of course, the higher the power level of the mobile communication device 122 receiving the reference signal generated by the wireless base station B11, the better. Via communications 242, the mobile communication device 122 communicates samples of the corresponding link quality metric (RSRP) collected over time through the wireless base station B11 to the communication management resource 140.

The mobile communication device 122 monitors one or more signals 232 received from the second wireless network 112 and any of its corresponding B base stations. For wireless network 112, the mobile communication device 122 generates samples for link quality information such as RSRQ (Reference Signal Received Quality). This may include the mobile communication device 122 receiving a respective reference signal transmitted by the wireless base station B11. In one example, the Reference Signal Received Quality (RSRQ) quantifies the quality of the received reference signal from the serving cell's base station B11. This metric measures the signal's strength, similar to Reference Signal Received Power (RSRP), but it can be configured to provide further assessment of the level of interference and noise in the received reference signal. Thus, via a signal 232, the mobile communication device 122 can be configured to receive a respective reference signal generated by the wireless base station B11. The mobile communication device 122 generates a respective link quality metric indicating a quality associated with receiving that reference signal. Of course, the higher the power quality of the mobile communication device 122 receiving the reference signal generated by the wireless base station B11, the better. Via communications 242, the mobile communication device 122 communicates samples of the corresponding link quality metric (RSRQ) collected over time through the wireless base station B11 to the communication management resource 140.

The mobile communication device 122 monitors one or more signals 232 received from the second wireless network 112 and any of its corresponding B base stations. For wireless network 112, the mobile communication device 122 generates samples for link quality information such as SINR (Signal Interference Noise Ratio). This may include the mobile communication device 122 receiving a respective signal transmitted by the wireless base station B11. In one example, the samples of SINR generated by the mobile communication device 122 measure signal quality: the strength of the wanted signal compared to the unwanted interference and noise. Thus, via a signal 232, the mobile communication device 122 can be configured to receive a respective reference signal generated by the wireless base station B11. The mobile communication device 122 generates a respective SINR link quality metric indicating a quality associated with receiving that reference signal. Of course, the higher the power quality of the mobile communication device 122 receiving the reference signal generated by the wireless base station B11, the better. Via communications 242, the mobile communication device 122 communicates samples of the corresponding SINR link quality metric collected over time through the wireless base station B11 to the communication management resource 140.

Thus, in a similar manner, each of the mobile communication devices in the network by 100 can be configured to support similar operations with respect to communication device 122 and communication device 122 above. In such an instance, the communication management resource 140 (a.k.a., controller) receives link quality samples (such as one or more of RSRP (Coverage), RSRQ and SINR samples) from each of the mobile communication devices in the network environment and from each of the different regions of wireless coverage.

Based on the received samples of link quality metrics received from the multiple mobile communication devices in a respective region of wireless coverage, the communication management resource 140 or other suitable entity generates one or more functions or values to track a different link quality metrics supported for the given region of wireless coverage. In one example, based on the received link quality metrics of the different communication devices, the communication management resource 140 generates averages of the samples to produce, for each wireless network, an average RSRP value (a.k.a., Avg RSRP), an average RSRQ value (a.k.a., Avg RSRQ), and an average SINR value (a.k.a., Avg SINR).

See below a list of different ranking of wireless connectivity conditions (7 conditions) based on the collected samples of RSRP (Coverage), RSRQ and SINR.
1. Excellent Service Region [Avg RSRP >−95 dBm, Avg RSRQ>−7, Avg SINR>15 dB]
2. Excellent Coverage but high Interference Region [Avg RSRP >−95 dBm, Avg RSRQ <−10, Avg SINR <5 dB]
3. Poor Coverage and high Interference Region [Avg RSRP <−105 dBm, Avg RSRQ <−15, Avg SINR <3 dB]
4. Poor Coverage and low Interference Region [Avg RSRP <−105 dBm, Avg RSRQ>−7, Avg SINR>15 dB]
5. Excellent Service Region limited by network load conditions [Avg RSRP >−95 dBm, Avg RSRQ>−7, Avg SINR>15 dB while 50% of network base stations are 70% or more utilized in a region]
6. Excellent Service Region with latency centric applications for moving mobile, voice users etc. [Avg RSRP >−95 dBm, Avg RSRQ>−7, Avg SINR>15 dB while 75% of the transitions are moving mobile and voice users]
7. Rest of the regions can be classified as a general group from which later the categorization can be done based on above [1-6] regions as applicable

For Each region, user experience can be monitored using user index consists of average CQI, SINR, RSRP, RSRQ and latency per individual sessions.

As further discussed herein, each of the samples link quality metrics can be used as a basis in which to generate a respective link quality distribution function, which is then used as a basis in which to control connectivity to the first wireless network and the second wireless network.

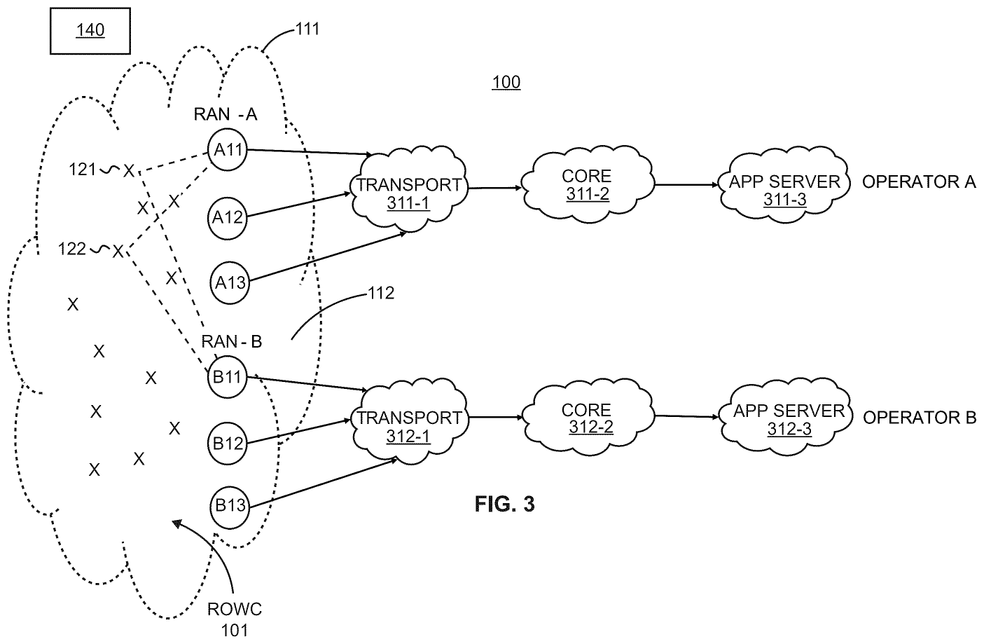

FIG. 3 is an example diagram illustrating an example network environment including multiple wireless networks as discussed herein.

As shown in FIG. 3, from a network architecture perspective, each of the wireless network 111 (such as RAN-A) and wireless network 112 (such as RAN-B) can be configured to have their own transport and core network along with application server. More specifically, the operator A has its own transport network 311-1, core network 311-2, and application server network 311-3. The operator B has its own transport network 312-1, core network 312-2, and application server network 312-3. Since geographical coverage areas may be overlapping, it is desirable to have coordination between RAN-A (network 111) and RAN-B (network 112) which are explained in the next section of this disclosure.

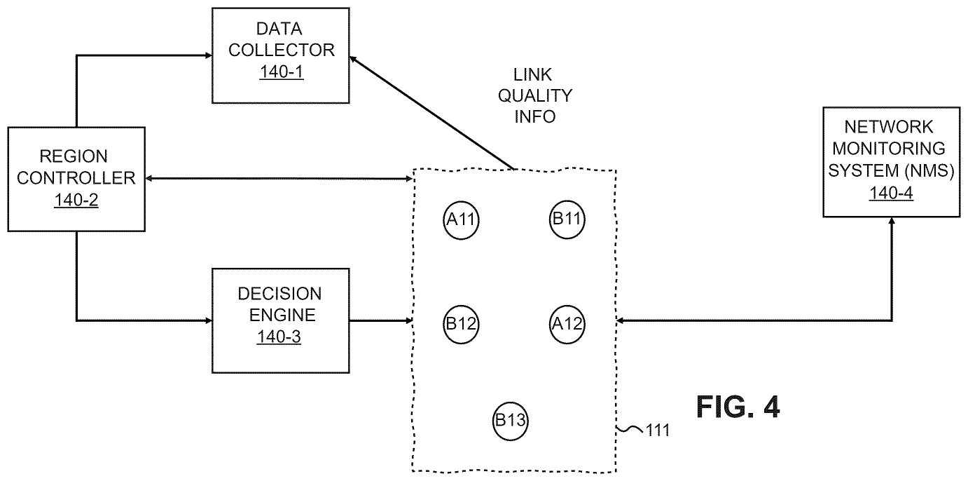

FIG. 4 is an example diagram illustrating monitoring and management of a respective wireless network as discussed herein.

In this example, and as previously discussed, the samples of link quality information (such as link quality metrics samples for each of multiple parameters RSRP, RSRQ, and SINR) collected from the communication devices are communicated through respective base stations to the communication management resource 140. In other words, the base stations report the measurements to the data collector 140-1 while region controller 140-2 or other suitable entity is configured to manage the records and maintain the region level monitoring to tweak the trigger (entry and exit thresholds) criterion on per region basis. As further shown, the decision engine 140-3 (a.k.a., decision maker) reviews the results (collection of link quality metrics for the different parameters) for certain period before making the decision, while continuing to monitor the user indices once the values are updated. This will help maintain customer experience of providing the communication devices than wireless service. The region controller 140-2 can be configured to have access to each of the radio base stations in a respective region wireless coverage. Group. At any point, the region controller 140-2 is able to make grouping decisions with respect to base stations and regroup base stations per region as needed. If desired, the network environment 100 can be configured to include the network monitoring system 140-4.

Note further that the decision engine 140-3 associated with the communication management resource 140 can be configured to use following criterions for making per region level entry and exit criterion for both networks based on both SIMs (RAN-A & RAN-B).

For example, one or more parameters such as region level RSRP (coverage), interference (SINR & RSRQ) can be monitored as previously discussed for making determinations of entry and exit criterion (such as decisions in which to hand off wireless connectivity of a respective mobile communication device from the first wireless network 111 to the second wireless network 112 or hand off the wireless connectivity of a respective mobile communication device from the second wireless network 112 to the first wireless network 111). There were 7 different types of regions of wireless coverage as previously discussed. Each of the 7 types of regions (7 conditions associated with a region of wireless coverage as discussed above) can be configured to have different entry-exit criterion (such as threshold levels) depending on radio conditions on the ground along with network utilization, etc.

In a given condition, such as RSRP (entry: >−114 dB), SINR (entry: >2.5 dB), RSRQ (entry: >−15.5 dB), the communication management resource 140 biases a respective mobile communication device to operate in the active mode with respect to the wireless network 111 to ask a corresponding user of the mobile communication device 121 subscribes. As further discussed below, the threshold can be of 85th percentile of total samples per region.

To transition a respective mobile communication device from the first wireless network 111 (set the mobile communication device 121 from the active mode to the standby mode for wireless network 111) to the second wireless network 112 (set the mobile communication device 121 from the standby mode to the active mode for wireless network 112), the configuration management resource 140 implements exit criterion from the first wireless network to the second wireless network using threshold information such as RSRP (exit: <−115 dB), SINR (exit: <0 dB), RSRQ (exit: −18 dB). Similar algorithm will be implemented in RAN-B network where exit and entrance criterion can be maintained on an as-needed basis.

As further discussed herein, implementation of Dynamic DSDS adjustments to the network biases the mobile communication device 121 (and any other mobile communication devices associated with operator A) towards using the wireless network 111 as the active network. Such techniques as discussed herein also help to maintain visitor network (such as wireless network 112) utilization by the mobile communication device 121 at a minimum and only on an as needed basis. By increasing On-Net time on home network (such as operating the mobile communication device 121 the active session mode with respect to the wireless network 111) will improve cost efficiency of the business model without compromising any user experience. By implementing intelligence to the application will help capture maximum time and traffic on per bin bases.

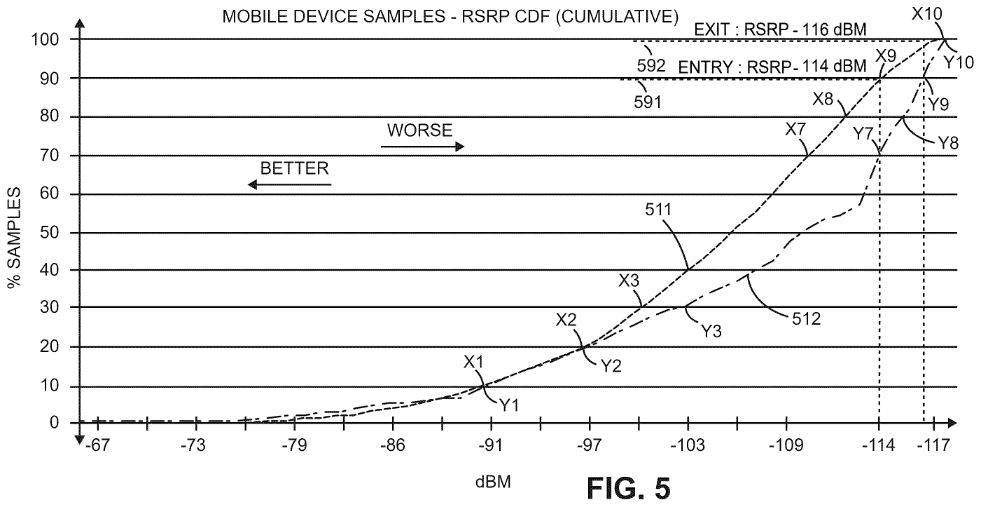

FIG. 5 is an example diagram illustrating a first link quality distribution function and a second link quality distribution function based on link quality parameter RSRP (Reference Signal Received Power) as discussed herein.

In this example, as previously discussed, the communication management resource 140 receives first samples of link quality metrics RSRP (Reference Signal Received Power) measurements as generated by the communication devices 121, 122, 123, etc., in the region of wireless coverage 101. In one example, the communication management resource 140 receives first link quality metrics indicating wireless link quality provided by first wireless base stations associated with the wireless network 111 to first mobile communication devices in the region of wireless coverage 101. Those devices providing the wireless link quality metrics in the region of wireless coverage 101 can be actively using either the first wireless network or the second wireless network to convey data to the remote network 190 or receive data from the remote network 190. As shown in FIG. 5, based on RSRP link quality metrics received from each of the multiple mobile communication devices in the region of wireless coverage 101, the communication management resource 140 produces the cumulative distribution function 511 for wireless network 111. The RSRP link quality metrics generally indicate a respective wireless power levels as measured by the respective mobile communication devices receiving a first wireless signal from one or more of the base stations A in the first wireless network 111 while in the region wireless coverage 101.

The distribution function 511 generally indicates how well the population of mobile communication devices in the region of wireless coverage 101 receives respective wireless signals from the base stations A1x (such as wireless base stations A11, A12, etc.) associated with the wireless network 111 and corresponding wireless network service provider/operator A.

In one example, the distribution function 511 is a cumulative distribution function of a percentage of link quality samples (y-axis) versus detected link quality (x-axis). In general, for any given point on the distribution function 511, the distribution function 511 on the y-axis for the given point indicates the respective percentage of mobile communication devices in the region of wireless coverage 101 that receive greater link quality than as indicated on the x-axis for the given point.

More specifically, the point X1 of the distribution function 511 indicates that 10 percent of the communication devices in the region of wireless coverage 101 report a link quality metric RSRP of between −67 and −91 dBm; the point X2 of the distribution function 511 indicates that 20 percent of the communication devices in the region of wireless coverage 101 report a link quality metric RSRP of between −67 and −96 dBm; the point X3 of the distribution function 511 indicates that 30 percent of the communication devices in the region of wireless coverage 101 report a link quality metric RSRP of between −67 and −100 dBm; . . . ; the point X7 of the distribution function 511 indicates that 70 percent of the communication devices in the region of wireless coverage 101 report a link quality metric RSRP of between −67 and −109 dBm; the point X8 of the distribution function 511 indicates that 80 percent of the communication devices in the region of wireless coverage 101 report a link quality metric RSRP of between −67 and −111 dBm; the point X9 of the distribution function 511 indicates that 90 percent of the communication devices in the region of wireless coverage 101 report a link quality metric RSRP of between −67 and −113 dBm; the point X10 of the distribution function 511 indicates that 100 percent of the communication devices in the region of wireless coverage 101 report a link quality metric RSRP of between −67 and −117 dBm.

Accordingly, the distribution function 511 indicates how well each of multiple different communication devices in the region of wireless coverage 101 receive signals from the wireless base stations Ax in the wireless network 111. Note that an RSRP link quality metric nearer to −67 dBm is much better than an RSRP link quality metric nearer to −117 dBm.

In a similar manner, the distribution function 512 generally indicates how well the population of mobile communication devices in the region of wireless coverage 101 receive respective wireless signals from the base stations B1x (such as wireless base stations B11, B12, etc.) associated with the wireless network 112 and corresponding wireless network service provider/operator B.

In one example, the distribution function 512 is a cumulative distribution function of a percentage of link quality samples (y-axis) versus link quality (x-axis). In general, for any given point on the distribution function 512, the distribution function 512 at the given point indicates the respective percentage on the y-axis of mobile communication devices in the region of wireless coverage 101 that receive greater link quality than as indicated on the x-axis for that given point.

More specifically, the point Y1 of the distribution function 512 indicates that 10 percent of the communication devices in the region of wireless coverage 101 report a link quality metric RSRP of between −67 and −91 dBm; the point Y2 of the distribution function 512 indicates that 20 percent of the communication devices in the region of wireless coverage 101 report a link quality metric RSRP of between −67 and −96 dBm; the point Y3 of the distribution function 512 indicates that 30 percent of the communication devices in the region of wireless coverage 101 report a link quality metric RSRP of between −67 and −100 dBm; . . . ; the point Y7 of the distribution function 512 indicates that 70 percent of the communication devices in the region of wireless coverage 101 report a link quality metric RSRP of between −67 and −114 dBm; the point Y8 of the distribution function 512 indicates that 80 percent of the communication devices in the region of wireless coverage 101 report a link quality metric RSRP of between −67 and −115 dBm; the point Y9 of the distribution function 512 indicates that 90 percent of the communication devices in the region of wireless coverage 101 report a link quality metric RSRP of between −67 and −116 dBm; the point Y10 of the distribution function 512 indicates that 100 percent of the communication devices in the region of wireless coverage 101 report a link quality metric RSRP of between −67 and −117 dBm.

Accordingly, the distribution function 512 indicates how well each of multiple different communication devices in the region of wireless coverage 101 receive signals from the wireless base stations Bx in the wireless network 111. As previously discussed, an RSRP link quality metric nearer to −67 dBm is much better than an RSRP link quality metric nearer to −116 dBm.

In general, the distribution function 512 indicates that the wireless network 112 and corresponding base stations Bx provide better wireless link quality to the communication devices in the region of wireless coverage 101. However, assume that the operator of the mobile communication device 121 subscribes to wireless services provided by the wireless network service provider A operating the wireless network 111 (so called home network). Assume that the wireless network service provider B operating the wireless network 112 is a visitor network potentially providing backup wireless services to the subscribers associated with the wireless network service provider A. In such an instance, it is desirable to provide wireless services from the wireless network 111 to the mobile communication device 121 as much as possible. However, in circumstances in which the wireless services provided by the wireless network 111 are unacceptable or nonexistent to corresponding communication devices in the region of wireless coverage 101, it is desirable to hand off the active session of the communication device 121 operating in the DSDS mode from the wireless network 111 to the wireless network 112. This ensures that the operator of the mobile communication device 121 constantly receives good wireless service to access the remote network 190 via communications through the wireless network 111 or the wireless network 112 as further discussed herein.

In accordance with further examples, the communication management resource 140 or other suitable entity generates respective threshold information associated with the distribution function 511 to control network transitions associated with each of the corresponding mobile communication devices in a respective region of wireless coverage. In this example, the communication management resource 140 generates the threshold information 591 (entry value of—114 dBm) as well as threshold information 592 such as (exit value of—116 dBm).

Accordingly, the threshold information associated with the distribution function 511 includes a first threshold value—114 dBm and a second threshold value—116 dBm. The first threshold value—114 dBm specifies a first threshold level of controlling the active session connectivity of the mobile communication device with respect to transition from the second wireless network 112 to the first wireless network 111. The second threshold value—116 dBm specifies a second threshold level of controlling the transition of the mobile communication device 121 from the first wireless network 111 to the second wireless network 112.

The first threshold level—116 dBm indicates a first link quality level in which to initiate network transition of active session connectivity of mobile communication devices (such as mobile communication device 121) from the first wireless network 111 to the second wireless network 112. In other words, assume that the mobile communication device 121 in the DSDS (Dual SIM Dual Standby) mode is actively connected with one or more wireless base stations associated with the wireless network 111 to communicate with the remote network 190 and corresponding one or more resources. The mobile communication device 121 is connected to wireless network 112, but in standby mode with respect to the second wireless network 112.

The mobile communication device 121 can be configured to constantly determine whether or not to switch over the active session SIM from the wireless network 111 to the wireless network 112 depending on a respective quality of communications received from the wireless network 111.

In one example, the mobile communication device 121 produces a respective current sample for the RSRP link quality value in a manner as previously discussed. This can include the mobile communication device 121 generating a respective RSRP link quality value of the mobile communication device 121 receiving one or more reference signals from the wireless network 111 and corresponding one or more wireless base stations.

Note that the decision of performing a respective active session network transition from one network another can be made by any suitable entity such as communication management resource 140, mobile communication device 121, etc. If desired, mobile communication device 121 itself includes a respective communication management resource to perform any of the operations such as provided by the communication management resource 140.

In furtherance of determining which of the multiple networks to provide active session connectivity, the communication management resource 140 or other suitable entity compares the generated RSRP link quality value (newly or recently measured by the mobile communication device 121) to the threshold information 592. If the communication management resource 140 determines that the RSRP link quality value is greater than the threshold level—116 dBm (to the left of the point on the distribution function 511 corresponding to the threshold—116 dBm), the communication management resource 140 prevents network transition of the active session from the first wireless network 111 (SIM 121-1) to the second wireless network 112 (SIM 121-2). Thus, because the link quality provided by the wireless network 111 is sufficiently good as indicated by the newly measured RSRP link quality value, there is no need to network transition the active session to the wireless network 112. Accordingly, the communication management resource 140 can be configured to prevent an active session network transition of the first mobile communication device 121 from the first wireless network 111 to the second wireless network 112 in response to detecting that the first link quality value is currently detected by the communication device 121 is greater than the first threshold level.

However, during the compare, if the communication management resource 140 determines that the newly measured RSRP link quality value is less than the threshold level—116 dBm (to the right of the point on the distribution function 511 corresponding to the threshold—116 dBm), the communication management resource 140 can be configured to initiate a network transition of the active session of the mobile communication device 121 from the first wireless network 111 (SIM 121-1) to the second wireless network 112 (SIM 121-2). Thus, because the link quality provided by the wireless network 111 is very bad such as less than the threshold level as indicated by threshold information 592, there is a need to network transition the active session to the wireless network 112.

As another example, assume that the mobile communication device 121 handed off its respective active session to the wireless network 112, meaning that the mobile communication device 121 is in a respective standby mode of connecting with the wireless network 111. As previously discussed, the communication management resource 140 and corresponding mobile communication device 121 desire to be connected to the wireless network 111 when the link quality provided by the wireless network 111 is sufficiently good.

While active session associated with the mobile communication device 121 is connected to the wireless network 112 and the mobile communication device 121 is in standby mode with respect to the wireless network 111, assume that the mobile communication device 121 produces a respective new sample for the RSRP link quality metric in a manner as previously discussed. This can include the mobile communication device 121 generating a respective RSRP link quality value of the mobile communication device 121 receiving one or more reference signals from the wireless network 111 and corresponding one or more wireless base stations. In one example, the communication management resource 140 or other suitable entity compares the newly measured RSRP link quality value as generated by the mobile communication device 121 or other suitable entity to the threshold information 591. If the communication management resource 140 determines that the RSRP link quality value is greater than the threshold level—114 dBm (to the left of the point on the distribution function 511 corresponding to the threshold—114 dBm), the communication management resource 140 initiates network transition of the active session from the second wireless network 112 (SIM 121-2) to the first wireless network 111 (SIM 121-1). Thus, because the link quality provided by the wireless network 111 is sufficiently good, there is no need to maintain the active session on the Accordingly, the communication management resource 140 can be configured to network transition the active session network transition of the first mobile communication device 121 from the second wireless network 112 to the first wireless network 111 in response to detecting that the newly obtained link quality value is greater than the second threshold level (entry threshold of—114 dBm). Subsequent to the active session network transition to the wireless network 111, the mobile communication device 121 is in the standby mode again with respect to wireless network 112. Accordingly, the second threshold level associated with the threshold information 591 indicates a second link quality level in which to control active session network transitions from the second wireless network 112 to the first wireless network 111.

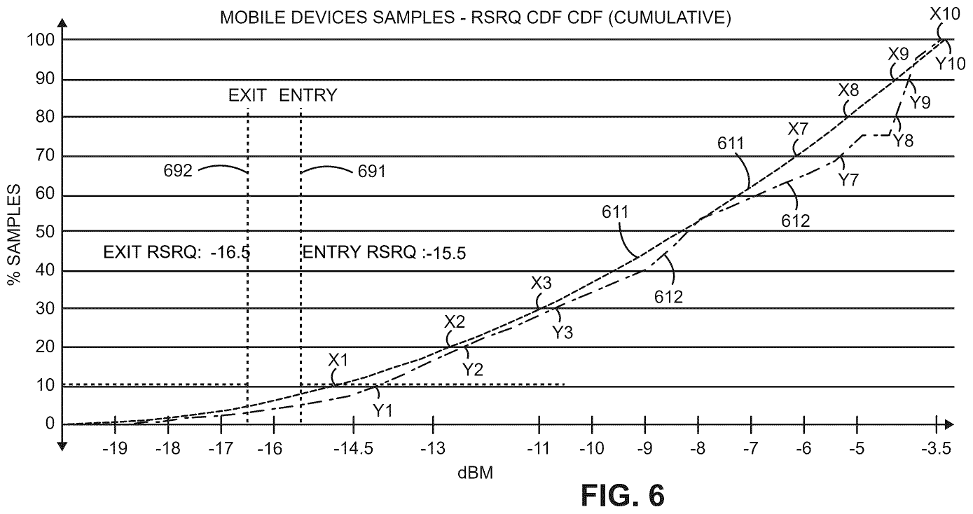

FIG. 6 is an example diagram illustrating a first link quality distribution function and a second link quality distribution function based on RSRQ as discussed herein.

In this example, as previously discussed, the communication management resource 140 receives first samples of link quality metrics RSRQ (Reference Signal Received Quality) measurements as generated by the communication devices 121, 122, 123, etc., in the region of wireless coverage 101. In one example, the communication management resource 140 receives first link quality metrics indicating wireless link quality provided by first wireless base stations associated with the wireless network 111 to first mobile communication devices in the region of wireless coverage 101. Those devices in the region of wireless coverage 101 providing the wireless link quality metrics can be actively using either the first wireless network or the second wireless network to convey data to the remote network 190 or receive data from the remote network 190. As shown in FIG. 6, based on RSRQ link quality metrics received from each of the multiple mobile communication devices in the region of wireless coverage 101, the communication management resource 140 produces the distribution function 611 for wireless network 111. The RSRQ link quality metrics generally indicate a respective wireless signal quality level as received by the respective mobile communication devices receiving a first wireless signal from the base stations in the first wireless network 111 while in the region wireless coverage 101.

The distribution function 611 generally indicates how well the population of mobile communication devices in the region of wireless coverage 101 receives respective wireless signals from the base stations A1x (such as wireless base stations A11, A12, etc.) associated with the wireless network 111 and corresponding wireless network service provider/operator A.

In one example, the distribution function 611 is a cumulative distribution function of a percentage of link quality samples (y-axis) versus detected link quality (x-axis). In general, for any given point on the distribution function 611, the distribution function 611 on the y-axis for the given point indicates the respective percentage of mobile communication devices in the region of wireless coverage 101 that receive lower link quality than as indicated on the x-axis for the given point.

More specifically, the point X1 of the distribution function 611 indicates that 10 percent of the communication devices in the region of wireless coverage 101 report a link quality metric RSRQ of between −19.5 and −14.5 dB; the point X2 of the distribution function 611 indicates that 20 percent of the communication devices in the region of wireless coverage 101 report a link quality metric RSRQ of between −19.5 and −12.5 dB; the point X3 of the distribution function 611 indicates that 30 percent of the communication devices in the region of wireless coverage 101 report a link quality metric RSRQ of between −19.5 and −10.5 dB; . . . ; the point X7 of the distribution function 611 indicates that 70 percent of the communication devices in the region of wireless coverage 101 report a link quality metric RSRQ of between −19.5 and −6 dB; the point X8 of the distribution function 611 indicates that 80 percent of the communication devices in the region of wireless coverage 101 report a link quality metric RSRQ of between −19.5 and −5 dB; the point X9 of the distribution function 511 indicates that 90 percent of the communication devices in the region of wireless coverage 101 report a link quality metric RSRQ of −19.5 and −4.5 dB; the point X10 of the distribution function 611 indicates that 100 percent of the communication devices in the region of wireless coverage 101 report a link quality metric RSRQ of between −19.5 and −3.5 dB.

Accordingly, the distribution function 611 indicates how well each of multiple different communication devices in the region of wireless coverage 101 receive signals from the wireless base stations Ax in the wireless network 111. Note that an RSRQ link quality metric nearer to −3.5 dB is much better than an RSRQ link quality metric near to −19.5 dB.

In a similar manner, the distribution function 612 generally indicates how well the population of mobile communication devices in the region of wireless coverage 101 receive respective wireless signals from the base stations B1x (such as wireless base stations B11, B12, etc.) associated with the wireless network 112 and corresponding wireless network service provider/operator B.

In one example, the distribution function 612 is a cumulative distribution function of a percentage of link quality samples (y-axis) versus link quality (x-axis). In general, for any given point on the distribution function 612, the distribution function 612 at the given point indicates the respective percentage on the y-axis of mobile communication devices in the region of wireless coverage 101 that receive lower link quality than as indicated on the x-axis for that given point.

More specifically, the point Y1 of the distribution function 612 indicates that 10 percent of the communication devices in the region of wireless coverage 101 report a link quality metric RSRQ of between −19.5 and −14 dB; the point Y2 of the distribution function 612 indicates that 20 percent of the communication devices in the region of wireless coverage 101 report a link quality metric RSRQ of between −19.5 and −12.5 dB; the point Y3 of the distribution function 612 indicates that 30 percent of the communication devices in the region of wireless coverage 101 report a link quality metric RSRQ of between −19.5 and −11 dB; . . . ; the point Y7 of the distribution function 612 indicates that 70 percent of the communication devices in the region of wireless coverage 101 report a link quality metric RSRQ of between −19.5 and −5 dB; the point Y8 of the distribution function 612 indicates that 80 percent of the communication devices in the region of wireless coverage 101 report a link quality metric RSRQ of between −19.5 and −4 dB; the point Y9 of the distribution function 511 indicates that 90 percent of the communication devices in the region of wireless coverage 101 report a link quality metric RSRQ of −19.5 and −4 dB; the point Y10 of the distribution function 612 indicates that 100 percent of the communication devices in the region of wireless coverage 101 report a link quality metric RSRQ of between −19.5 and −3.5 dB.

Accordingly, the distribution function 612 indicates how well each of multiple different communication devices in the region of wireless coverage 101 receive signals from the wireless base stations Bx in the wireless network 111. As previously discussed, an RSRQ link quality metric nearer to −20 dB is much less than an RSRQ link quality metric nearer to −3.5 dB.

In general, the distribution function 612 indicates that the wireless network 112 and corresponding base stations Bx provide better wireless link quality to the communication devices in the region of wireless coverage 101. However, assume that the operator of the mobile communication device 121 subscribes to wireless services provided by the wireless network service provider A operating the wireless network 111 (so called home network). Assume that the wireless network service provider B operating the wireless network 112 is a visitor network potentially providing backup wireless services to the subscribers associated with the wireless network service provider A. In such an instance, it is desirable to provide wireless services from the wireless network 111 to the mobile communication device 121 as much as possible. However, in circumstances in which the wireless services provided by the wireless network 111 are unacceptable or nonexistent to corresponding communication devices in the region of wireless coverage 101, it is desirable to hand off the communication device 121 from the wireless network 111 to the wireless network 112. This ensures that the operator of the mobile communication device 121 constantly receives good wireless service to access the remote network 190 via communications through the wireless network 111 or the wireless network 112 as further discussed herein.

In accordance with further examples, the communication management resource 140 or other suitable entity generates respective threshold information associated with the distribution function 611 to control network transitions associated with each of the corresponding mobile communication devices in a respective region of wireless coverage 101. In this example, the communication management resource 140 generates the threshold information 691 (entry value of—15.5 dB) as well as threshold information 692 such as (exit value of—16.5 dB).

Accordingly, the threshold information associated with the distribution function 611 includes a first threshold value—15.5 dB and a second threshold value—16.5 dB. The first threshold value—15.5 dB specifies a first threshold level of controlling the active session connectivity of the mobile communication device with respect to the first wireless network 111 and the second wireless network 112. The second threshold value—16.5 dB specifying a second threshold level of controlling the connectivity of the mobile communication device 121 with respect to the first wireless network 111 and the second wireless network 112.

The threshold level—16.5 dB indicates a first link quality level in which to initiate network transition of active session connectivity of mobile communication devices (such as mobile communication device 121) from the first wireless network 111 to the second wireless network 112. In other words, assume that the mobile communication device 121 in the DSDS (Dual SIM Dual Standby) mode is actively connected with one or more wireless base stations associated with the wireless network 111 to communicate with the remote network 190 and corresponding one or more resources. The mobile communication device 121 is connected to wireless network 111, but in standby mode with respect to the second wireless network 112.

The mobile communication device 121 can be configured to constantly determine whether or not to switch over the active session SIM from the wireless network 111 to the wireless network 112 depending on a respective quality of communications received from the wireless network 111.

In one example, the mobile communication device 121 produces a respective sample for the RSRQ link quality value in a manner as previously discussed. This can include the mobile communication device 121 generating a respective RSRQ link quality value of the mobile communication device 121 receiving one or more reference signals from the wireless network 111 and corresponding one or more wireless base stations.

Note that the decision of performing a respective active session network transition from one network to another can be made by any suitable entity such as communication management resource 140, mobile communication device 121, etc. If desired, mobile communication device 121 itself includes a respective communication management resource to perform any of the operations such as provided by the communication management resource 140.

In furtherance of determining which of the multiple networks to provide active session connectivity, the communication management resource 140 or other suitable entity compares the RSRQ link quality value (newly or recently measured by the mobile communication device 121) to the threshold information 692. If the communication management resource 140 determines that the RSRQ link quality value is greater than the threshold level—16.5 dB (to the right of the point on the distribution function 611 corresponding to the threshold—16.5 dB), the communication management resource 140 prevents a network transition of the active session from the first wireless network 111 (SIM 121-1) to the second wireless network 112 (SIM 121-2). Thus, because the link quality provided by the wireless network 111 is sufficiently good as indicated by the newly measured RSRQ link quality value, there is no need to network transition the active session to the wireless network 112. Accordingly, the communication management resource 140 can be configured to prevent an active session network transition of the first mobile communication device 121 from the first wireless network 111 to the second wireless network 112 in response to detecting that the first newly received or measured link quality value is greater than the first threshold level.

However, during the compare, if the communication management resource 140 determines that the newly measured RSRQ link quality value is less than the threshold level—16.5 dB (to the left of the point on the distribution function 611 corresponding to the threshold—16.5 dB), the communication management resource 140 can be configured to initiate a network transition of the active session of the mobile communication device 121 from the first wireless network 111 (SIM 121-1) to the second wireless network 112 (SIM 121-2). Thus, because the link quality provided by the wireless network 111 is very bad such as less than the threshold level as indicated by threshold information 692, there is a need to network transition the active session to the

As another example, assume that the mobile communication device 121 handed off its respective active session to the wireless network 112, meaning that the mobile communication device 121 is in a respective standby mode of connecting with the wireless network 111. As previously discussed, the communication management resource 140 and corresponding mobile communication device 121 desire to be connected to the wireless network 111 when the link quality provided by the wireless network 111 is sufficiently good.

While the active session associated with the mobile communication device 121 is connected to the wireless network 112 and the mobile communication device 121 is in standby mode with respect to the wireless network 111, assume that the mobile communication device 121 produces a respective new sample for the RSRQ link quality value in a manner as previously discussed. This can include the mobile communication device 121 generating a respective RSRQ link quality value of the mobile communication device 121 receiving one or more reference signals from the wireless network 111 and corresponding one or more wireless base stations. In one example, the communication management resource 140 or other suitable entity compares the newly measured RSRQ link quality value as generated by the mobile communication device 121 or other suitable entity to the threshold information 691. If the communication management resource 140 determines that the RSRQ link quality value is greater than the threshold level—15.5 dB (to the right of the point on the distribution function 511 corresponding to the threshold—15.5 dB), the communication management resource 140 initiates network transition of the active session from the second wireless network 112 (SIM 121-2) to the first wireless network 111 (SIM 121-1). Thus, because the link quality provided by the wireless network 111 is sufficiently good, there is no need to maintain the active session on the wireless network 112.

Accordingly, the communication management resource 140 can be configured to network transition the active session network transition of the first mobile communication device 121 from the second wireless network 112 to the first wireless network 111 in response to detecting that the newly obtained link quality value is greater than the second threshold level (entry threshold of—15.5 dB). Subsequent to the active session network transition to the wireless network 111, the mobile communication device 121 is in the standby mode again with respect to wireless network 112. Accordingly, the second threshold level associated with the threshold information 691 indicates a second link quality level in which to control active session network transitions from the second wireless network 112 to the first wireless network 111.

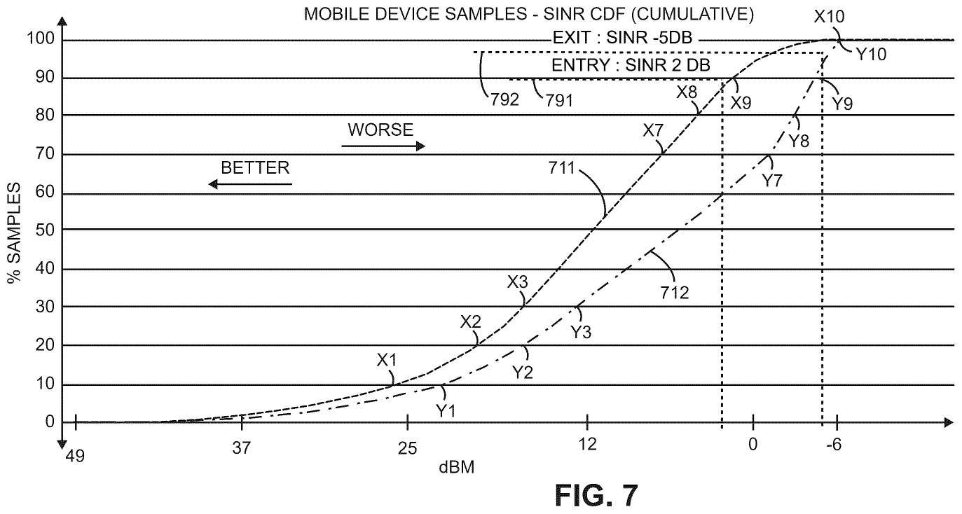

FIG. 7 is an example diagram illustrating a first link quality distribution function and a second and quality distribution function based on SINR (Signal Interference Noise Ratio) as discussed herein.

In this example, as previously discussed, the communication management resource 140 receives first samples of link quality metrics SINR measurements as generated by the communication devices 121, 122, 123, etc., in the region of wireless coverage 101. In one example, the communication management resource 140 receives first link quality metrics indicating wireless link quality provided by first wireless base stations associated with the wireless network 111 to first mobile communication devices in the region of wireless coverage 101. Those devices providing the wireless link quality metrics can be actively using either the first wireless network or the second wireless network to convey data to the remote network 190 or receive data from the remote network 190.

As shown in FIG. 7, based on SINR link quality metrics received from each of the multiple mobile communication devices in the region of wireless coverage 101, the communication management resource 140 produces the distribution function 711. The SINR link quality metrics generally indicate a respective wireless power levels as measured by the respective mobile communication devices receiving a first wireless signal from the base stations in the first wireless network while in the region wireless coverage 101.

The distribution function 711 generally indicates how well the population of mobile communication devices in the region of wireless coverage 101 receives respective wireless signals from the base stations A1x (such as wireless base stations A11, A12, etc.) associated with the wireless network 111 and corresponding wireless network service provider/operator A.

In one example, the distribution function 711 is a cumulative distribution function of a percentage of link quality samples (y-axis) versus detected link quality (x-axis). In general, for any given point on the distribution function 711, the distribution function 711 on the y-axis for the given point indicates the respective percentage of mobile communication devices in the region of wireless coverage 101 that receive greater link quality than as indicated on the x-axis for the given point.

More specifically, the point X1 of the distribution function 711 indicates that 10 percent of the communication devices in the region of wireless coverage 101 report a link quality metric SINR of between 50 and 27 dB; the point X2 of the distribution function 711 indicates that 20 percent of the communication devices in the region of wireless coverage 101 report a link quality metric SINR of between 50 and 22 dB; the point X3 of the distribution function 711 indicates that 30 percent of the communication devices in the region of wireless coverage 101 report a link quality metric SINR of between 50 and 17 dB; . . . ; the point X7 of the distribution function 711 indicates that 70 percent of the communication devices in the region of wireless coverage 101 report a link quality metric SINR of between 50 and 7 dB; the point X8 of the distribution function 711 indicates that 80 percent of the communication devices in the region of wireless coverage 101 report a link quality metric SINR of between 50 and 5 dB; the point X9 of the distribution function 511 indicates that 90 percent of the communication devices in the region of wireless coverage 101 report a link quality metric SINR of 50 and 2 dB; the point X10 of the distribution function 711 indicates that 100 percent of the communication devices in the region of wireless coverage 101 report a link quality metric SINR of between 50 and −6 dB.

Accordingly, the distribution function 711 indicates how well each of multiple different communication devices in the region of wireless coverage 101 receive signals from the wireless base stations Ax in the wireless network 111. Note that an SINR link quality metric nearer to 50 dB is much better than an SINR link quality metric near to −6 dB.

In a similar manner, the distribution function 712 generally indicates how well the population of mobile communication devices in the region of wireless coverage 101 receive respective wireless signals from the base stations B1x (such as wireless base stations B11, B12, etc.) associated with the wireless network 112 and corresponding wireless network service provider/operator B.

In one example, the distribution function 712 is a cumulative distribution function of a percentage of link quality samples (y-axis) versus link quality (x-axis). In general, for any given point on the distribution function 712, the distribution function 712 at the given point indicates the respective percentage on the y-axis of mobile communication devices in the region of wireless coverage 101 that receive greater link quality than as indicated on the x-axis for that given point.

More specifically, the point Y1 of the distribution function 712 indicates that 10 percent of the communication devices in the region of wireless coverage 101 report a link quality metric SINR of between 50 and 23 dB; the point Y2 of the distribution function 712 indicates that 20 percent of the communication devices in the region of wireless coverage 101 report a link quality metric SINR of between 50 and 17 dB; the point Y3 of the distribution function 712 indicates that 30 percent of the communication devices in the region of wireless coverage 101 report a link quality metric SINR of between 50 and 13 dB; . . . ; the point Y7 of the distribution function 712 indicates that 70 percent of the communication devices in the region of wireless coverage 101 report a link quality metric SINR of between 50 and −2 dB; the point Y8 of the distribution function 712 indicates that 80 percent of the communication devices in the region of wireless coverage 101 report a link quality metric SINR of between 50 and −3 dB; the point Y9 of the distribution function 712 indicates that 90 percent of the communication devices in the region of wireless coverage 101 report a link quality metric SINR of 50 and −4 dB; the point Y10 of the distribution function 712 indicates that 100 percent of the communication devices in the region of wireless coverage 101 report a link quality metric SINR of between 50 and −6 dB.

Accordingly, the distribution function 712 indicates how well each of multiple different communication devices in the region of wireless coverage 101 receive signals from the wireless base stations Bx in the wireless network 111. As previously discussed, an SINR link quality metric nearer to 50 dB is much better than an SINR link quality metric nearer to −6 dB.

In general, the distribution function 712 indicates that the wireless network 112 and corresponding base stations Bx provide better wireless link quality to the communication devices in the region of wireless coverage 101. However, assume that the operator of the mobile communication device 121 subscribes to wireless services provided by the wireless network service provider A operating the wireless network 111 (so called home network). Assume that the wireless network service provider B operating the wireless network 112 is a visitor network potentially providing backup wireless services to the subscribers associated with the wireless network service provider A. In such an instance, it is desirable to provide wireless services from the wireless network 111 to the mobile communication device 121 as much as possible. However, in circumstances in which the wireless services provided by the wireless network 111 are unacceptable or nonexistent to corresponding communication devices in the region of wireless coverage 101, it is desirable to hand off the communication device 121 from the wireless network 111 to the wireless network 112. This ensures that the operator (a.k.a., user) of the mobile communication device 121 constantly receives good wireless service to access the remote network 190 via communications through the wireless network 111 or the wireless network 112 as further discussed herein.

In accordance with further examples, the communication management resource 140 or other suitable entity generates respective threshold information associated with the distribution function 711 to control network transitions associated with each of the corresponding mobile communication devices in a respective region of wireless coverage. In this example, the communication management resource 140 generates the threshold information 791 (entry value of 2 dB) as well as threshold information 792 such as (exit value of—6 dB).

Accordingly, the threshold information associated with the distribution function 711 includes a first threshold value 2 dB and a second threshold value—5 dB. The first threshold value 2 dB specifies a first threshold level of controlling the active session connectivity of the mobile communication device with respect to the first wireless network 111 and the second wireless network 112. The second threshold value—5 dB specifying a second threshold level of controlling the connectivity of the mobile communication device 121 with respect to the first wireless network 111 and the second wireless network 112.

The first threshold level—5 dB indicates a first link quality level in which to initiate network transition of active session connectivity of mobile communication devices (such as mobile communication device 121) from the first wireless network 111 to the second wireless network 112. In other words, assume that the mobile communication device 121 in the DSDS (Dual SIM Dual Standby) mode is actively connected with one or more wireless base stations associated with the wireless network 111 to communicate with the remote network 190 and corresponding one or more resources. The mobile communication device 121 is connected to wireless network 112, but in standby mode with respect to the second wireless network 112.

The mobile communication device 121 can be configured to constantly determine whether or not to switch over the active session SIM from the wireless network 111 to the wireless network 112 depending on a respective quality of communications received from the wireless network 111.

In one example, the mobile communication device 121 produces a respective sample for the SINR link quality value in a manner as previously discussed. This can include the mobile communication device 121 generating a respective SINR link quality value of the mobile communication device 121 receiving one or more reference signals from the wireless network 111 and corresponding one or more wireless base stations.

Note that the decision of performing a respective active session network transition from one network to another can be made by any suitable entity such as communication management resource 140, mobile communication device 121, etc. If desired, mobile communication device 121 itself includes a respective communication management resource to perform any of the operations such as provided by the communication management resource 140.

In furtherance of determining which of the multiple networks to provide active session connectivity, the communication management resource 140 or other suitable entity compares the new or recent SINR link quality value (newly or recently measured by the mobile communication device 121) to the threshold information 792. If the communication management resource 140 determines that the SINR link quality value is greater than the threshold level 2 dB (to the left of the point on the distribution function 711 corresponding to the threshold 2 dB), the communication management resource 140 prevents network transition of the active session from the first wireless network 111 (SIM 121-1) to the second wireless network 112 (SIM 121-2) even if the wireless network provides better wireless link quality. Thus, because the link quality provided by the wireless network 111 is sufficiently good as indicated by the newly measured SINR link quality value, there is no need to network transition the active session to the wireless network 112. Accordingly, the communication management resource 140 can be configured to prevent an active session network transition of the first mobile communication device 121 from the first wireless network 111 to the second wireless network 112 in response to detecting that the first newly received or measured link quality value is greater than the first threshold level.

However, during the compare, if the communication management resource 140 determines that the newly measured SINR link quality value is less than the threshold level—5 dB (to the right of the point on the distribution function 511 corresponding to the threshold—5 dB), the communication management resource 140 can be configured to initiate a network transition of the active session of the mobile communication device 121 from the first wireless network 111 (SIM 121-1) to the second wireless network 112 (SIM 121-2). In one example, the network transition from the first wireless network to the second wireless network may be contingent upon the mobile communication device 121 detecting that the SINR link quality provided by the second wireless network is better than the corresponding threshold level such as greater than 2 dB. Thus, because the link quality provided by the wireless network 111 is very bad such as less than the threshold level as indicated by threshold information 792, there is a need to network transition the active session to the wireless network 112.

As another example, assume that the mobile communication device 121 handed off its respective active session to the wireless network 112, meaning that the mobile communication device 121 is in a respective standby mode of connecting with the wireless network 111. As previously discussed, the communication management resource 140 and corresponding mobile communication device 121 desire to be connected to the wireless network 111 when the link quality provided by the wireless network 111 is sufficiently good.

While the active session associated with the mobile communication device 121 is connected to the wireless network 112 and the mobile communication device 121 is in standby mode with respect to the wireless network 111, assume that the mobile communication device 121 produces a respective new sample for the SINR link quality value in a manner as previously discussed. This can include the mobile communication device 121 generating a respective SINR link quality value of the mobile communication device 121 receiving one or more reference signals from the wireless network 111 and corresponding one or more wireless base stations. In one example, the communication management resource 140 or other suitable entity compares the newly measured SINR link quality value is generated by the mobile communication device 121 or other suitable entity to the threshold information 791. If the communication management resource 140 determines that the SINR link quality value is greater than the threshold level 2 dB (to the left of the point on the distribution function 511 corresponding to the threshold 2 dB), the communication management resource 140 initiates network transition of the active session from the second wireless network 112 (SIM 121-2) to the first wireless network 111 (SIM 121-1). Thus, because the link quality provided by the wireless network 111 is sufficiently good, there is no need to maintain the active session on the wireless network 112.

Accordingly, the communication management resource 140 can be configured to network transition the active session network transition of the first mobile communication device 121 from the second wireless network 112 to the first wireless network 111 in response to detecting that the newly obtained link quality value is greater than the second threshold level (entry threshold of 2 dB). Subsequent to the active session network transition to the wireless network 111, the mobile communication device 121 is in the standby mode again with respect to wireless network 112. Accordingly, the second threshold level associated with the threshold information 791 indicates a second link quality level in which to control active session network transitions from the second wireless network 112 to the first wireless network 111.

Note that further examples herein include using a combination of received link quality values for different parameters RSRP, SINR, RSRQ as discussed herein at a given point or range of time as a basis in which to determine whether or not to network transition a respective active communication session from one wireless network to another while the corresponding mobile communication device 121 is in the DSDS mode. For example, there are 7 different conditions in which to determine whether or not the region of wireless coverage provides good conveyance of wireless data for communication devices in the respective region of wireless coverage 101. These conditions can be used as a basis in which to determine whether or not to network transition from one network to the other.

As previously discussed, the mobile communication device 121 can be configured to generate link quality values for each of the 3 different types of metrics in the FIGS. 5-7. If the mobile communication device 121 is currently active with respect to the first wireless network 111, and 2 out of the 3 link quality values indicate to remain on the wireless network 111, then the communication management resource 140 can be configured to prevent network transition of the active session from the first wireless network 111 to the second wireless network 112. However, there may be a case where to 2 out of the 3 link quality values are greater than respective thresholds (exit threshold). In such an instance, the communication management resource 140 can be configured to initiate network transition of the active session from the first wireless network 111 to the second wireless network 112.

Additionally, for each of the 3 graphs RSRP, SINR, RSRQ in respective FIGS. 5-7, the corresponding distribution functions associated with the second wireless network 112 may be to the left or right of the respective distribution functions associated with the first wireless network 111. This just means that the second network may be better or worse than the first network for that particular performance parameter. In one example, there is no desire to connect to the first wireless network 111 unless the threshold level information for the first network in that graph indicates that it may be better to exit to the second network. If desired, the communication management resource 140 can be configured to consider whether to exit an active session from the first wireless network 111 to the second wireless network 112 because the second wireless network actually might provide worse link quality than the first wireless network as indicated by the respective distribution functions. Thus another consideration by the communication management resource 140 to initiate a respective network transition of the active communication session from the first wireless network 111 to the second wireless network 112 if the corresponding distribution function or newly received link quality information received from the second wireless network as previously discussed indicates that the second wireless network 112 is a good option (the second wireless network 112 provides better performance for one or more of the different performance metrics) to initiate the network transition.

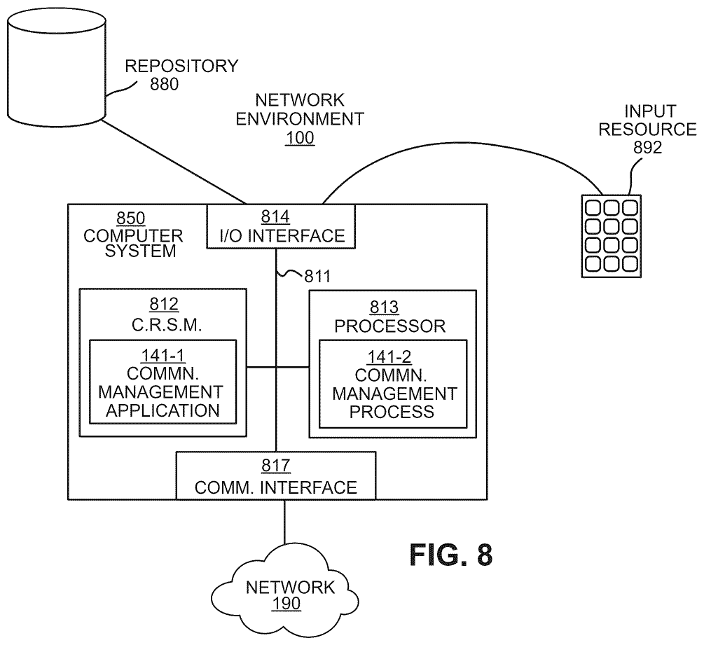

FIG. 8 is an example block diagram of a computer system for implementing any of the operations as previously discussed as described herein.

Note that any of the resources (such as communication management resource 140, data collector 140-1, controller 140-2, decision engine 140-3, network monitoring system 140-4, mobile communication device 121, mobile communication device 122, etc.) as discussed herein can be configured to include computer processor hardware and/or corresponding executable instructions to carry out the different operations as discussed herein.

For example, as shown, computer system 850 of the present example includes interconnect 811 coupling computer readable storage media 812 such as a non-transitory type of media (which can be any suitable type of hardware storage medium in which digital information can be stored and or retrieved), a processor 813 (computer processor hardware), I/O interface 814, and a communications interface 817.

I/O interface(s) 814 supports connectivity to repository 880 and input resource 892.

Computer readable storage medium 812 can be any hardware storage device such as memory, optical storage, hard drive, floppy disk, etc. In one embodiment, the computer readable storage medium 812 stores instructions and/or data.

As shown, computer readable storage media 812 can be encoded with management application 140-A (e.g., including instructions) in a respective wireless station to carry out any of the operations as discussed herein.

During operation of one embodiment, processor 813 accesses computer readable storage media 812 via the use of interconnect 811 in order to launch, run, execute, interpret or otherwise perform the instructions in management application 140-A stored on computer readable storage medium 812. Execution of the management application 140-A produces management process 140-B to carry out any of the operations and/or processes as discussed herein.

Those skilled in the art will understand that the computer system 850 can include other processes and/or software and hardware components, such as an operating system that controls allocation and use of hardware resources to execute the management application 140-A.

In accordance with different embodiments, note that computer system may reside in any of various types of devices, including, but not limited to, a mobile computer, a personal computer system, a wireless device, a wireless access point, a base station, phone device, desktop computer, laptop, notebook, netbook computer, mainframe computer system, handheld computer, workstation, network computer, application server, storage device, a consumer electronics device such as a camera, camcorder, set top box, mobile device, video game console, handheld video game device, a peripheral device such as a switch, modem, router, set-top box, content management device, handheld remote control device, any type of computing or electronic device, etc. The computer system 850 may reside at any location or can be included in any suitable resource in any network environment to implement functionality as discussed herein.

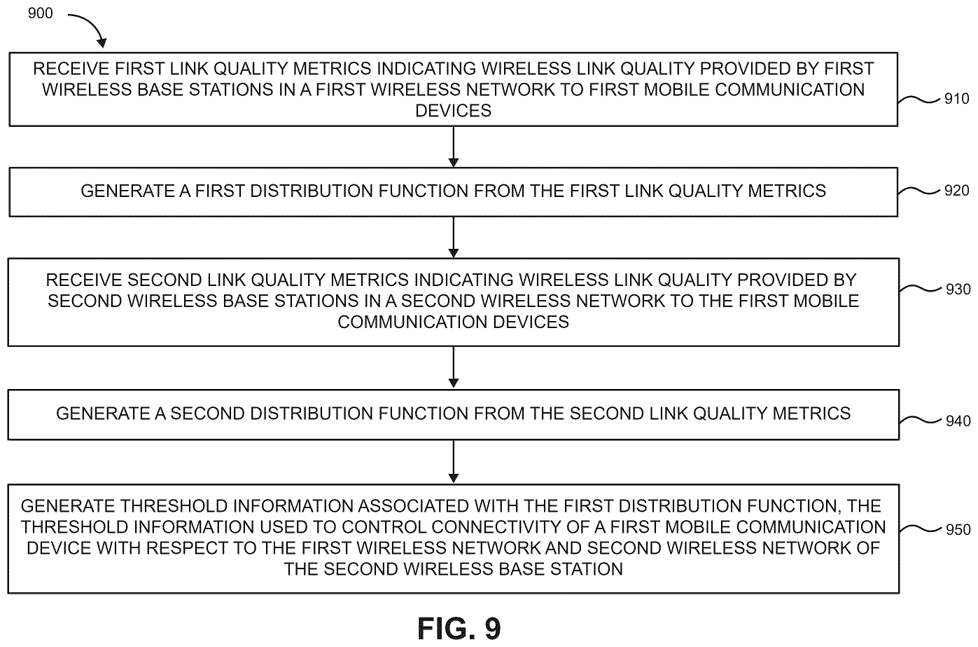

Functionality supported by the different resources will now be discussed via flowcharts in FIG. 9. Note that the steps in the flowcharts below can be executed in any suitable order.

FIG. 9 is a flowchart 900 illustrating an example method as described herein. Note that there will be some overlap with respect to concepts as discussed above.

In processing operation 910, the communication management resource 140 receives first link quality metrics indicating wireless link quality provided by first wireless base stations in a first wireless network 111 to first mobile communication devices associated with a corresponding first wireless network operator.

In processing operation 920, the communication management resource 140 generates one or more first distribution functions from the received first link quality metrics. In one example, each of the first distribution functions is a cumulative distribution function derived from samples of wireless link quality metrics received from and/or generated by the first mobile communication devices for the first network 111.

In processing operation 930, the communication management resource receives second link quality metrics indicating wireless link quality provided by second wireless base stations in the first wireless network to the first mobile communication devices.

In processing operation 940, the communication management resource 140 generates one or more first distribution functions from the received second link quality metrics. In one example, each of the second distribution functions is a cumulative distribution function derived from samples of wireless link quality metrics received from and/or generated by the first mobile communication devices for the second network 112.

In processing operation 950, the communication management resource 140 generates threshold information associated with the first distribution function. The threshold information (such as entrance and exit criteria) is subsequently used to control connectivity of one or more mobile communication devices with respect to the first wireless network and a second wireless network of second wireless base stations.

Note again that techniques herein are well suited to control connectivity of one or more mobile communication devices with respect to a primary wireless network and a secondary wireless network. However, it should be noted that techniques herein are not limited to use in such applications and that the techniques discussed herein are well suited for other applications as well.

Based on the description set forth herein, numerous specific details have been set forth to provide a thorough understanding of claimed subject matter. However, it will be understood by those skilled in the art that claimed subject matter may be practiced without these specific details. In other instances, methods, apparatuses, systems, etc., that would be known by one of ordinary skill have not been described in detail so as not to obscure claimed subject matter. Some portions of the detailed description have been presented in terms of algorithms or symbolic representations of operations on data bits or binary digital signals stored within a computing system memory, such as a computer memory. These algorithmic descriptions or representations are examples of techniques used by those of ordinary skill in the data processing arts to convey the substance of their work to others skilled in the art. An algorithm as described herein, and generally, is considered to be a self-consistent sequence of operations or similar processing leading to a desired result. In this context, operations or processing involve physical manipulation of physical quantities. Typically, although not necessarily, such quantities may take the form of electrical or magnetic signals capable of being stored, transferred, combined, compared or otherwise manipulated. It has been convenient at times, principally for reasons of common usage, to refer to such signals as bits, data, values, elements, symbols, characters, terms, numbers, numerals or the like. It should be understood, however, that all of these and similar terms are to be associated with appropriate physical quantities and are merely convenient labels. Unless specifically stated otherwise, as apparent from the following discussion, it is appreciated that throughout this specification discussions utilizing terms such as “processing,” “computing,” “calculating,” “determining” or the like refer to actions or processes of a computing platform, such as a computer or a similar electronic computing device, that manipulates or transforms data represented as physical electronic or magnetic quantities within memories, registers, or other information storage devices, transmission devices, or display devices of the computing platform.

While this invention has been particularly shown and described with references to preferred embodiments thereof, it will be understood by those skilled in the art that various changes in form and details may be made therein without departing from the spirit and scope of the present application as defined by the appended claims. Such variations are intended to be covered by the scope of this present application. As such, the foregoing description of embodiments of the present application is not intended to be limiting. Rather, any limitations to the invention are presented in the following claims.

I claim:

1. A method comprising:
receiving first link quality metrics indicating wireless link quality provided by first wireless base stations in a first wireless network to first mobile communication devices;
generating a first distribution function from the first link quality metrics; and
generating threshold information associated with the first distribution function, the threshold information used to control connectivity of a first mobile communication device with respect to the first wireless network and a second wireless network.

2. The method as in claim 1, wherein the threshold information is first threshold information, the method further comprising:
receiving second link quality metrics indicating wireless link quality provided by second wireless base stations in the second wireless network to the first mobile communication devices;
generating a second distribution function from the second link quality metrics; and
based on the second distribution function, controlling the connectivity of the first mobile communication device with respect to the first wireless network and the second wireless network.

3. The method as in claim 1, wherein the threshold information includes a first threshold value and a second threshold value, the first threshold value specifying a first threshold level of controlling the connectivity of the first mobile communication device with respect to the first wireless network and the second wireless network, the second threshold value specifying a second threshold level of controlling the connectivity of the first mobile communication device with respect to the first wireless network and the second wireless network.

4. The method as in claim 3, wherein the first threshold value indicates a first link quality level in which to control active session network transition of the first mobile communication device from the first wireless network to the second wireless network; and
wherein the second threshold value indicates a second link quality level in which to control active session network transition of the first mobile communication device from the second wireless network to the first wireless network.

5. The method as in claim 4, wherein the active session network transition of the first mobile communication device from the first wireless network to the second wireless network depends on a first link quality value and a second link quality value;
wherein the first link quality metric indicates a first wireless link value of the first mobile communication device receiving first wireless communications from the first wireless network, the first wireless link quality value measured by the first mobile communication device; and
wherein the second link quality value indicates a second wireless link quality of the first mobile communication device receiving second wireless communications from the second wireless network, the second wireless link quality value measured by the first mobile communication device.

6. The method as in claim 1, wherein the threshold information includes a first threshold level and a second threshold level, the first threshold level indicating a first link quality level in which to initiate network transitions from the first wireless network to the second wireless network, the second threshold level indicating a second link quality level in which to control active session network transitions from the second wireless network to the first wireless network.

7. The method as in claim 6 further comprising:
receiving a first link quality value indicating a link quality of a first mobile communication device receiving first wireless communications from the first wireless network; and
comparing the first link quality value to the first threshold level.

8. The method as in claim 7 further comprising:
initiating an active session network transition of the first mobile communication device from the first wireless network to the second wireless network in response to detecting that the first link quality value is less than the first threshold level.

9. The method as in claim 7 further comprising:
initiating an active session network transition of the first mobile communication device from the second wireless network to the first wireless network in response to detecting that the first link quality value is greater than the second threshold level.

10. The method as in claim 7 further comprising:
preventing an active session network transition of the first mobile communication device from the first wireless network to the second wireless network in response to detecting that the first link quality value is greater than the first threshold level.

11. The method as in claim 1, wherein the wireless link quality as indicated by the first link quality metrics are generated based on feedback from each respective mobile communication device of the first mobile communication devices.

12. The method as in claim 11, wherein the first link quality metrics include:
i) a wireless power level as measured by the respective mobile communication device receiving a first wireless signal from the first wireless network, and
ii) a signal-to-noise ratio as measured by the respective mobile communication device receiving the second wireless signal from the wireless network.

13. A system comprising:
communication management hardware operative to:
receive first link quality metrics indicating wireless link quality provided by first wireless base stations in a first wireless network to first mobile communication devices;
generate a first distribution function from the first link quality metrics; and
generate threshold information associated with the first distribution function, the threshold information used to control connectivity of a first mobile communication device with respect to the first wireless network and a second wireless network.

14. The system as in claim 13, wherein the threshold information is first threshold information, the communication management hardware further operative to:
receive second link quality metrics indicating wireless link quality provided by second wireless base stations in the second wireless network to the first mobile communication devices;
generate a second distribution function from the second link quality metrics; and
based on the second distribution function, control the connectivity of the first mobile communication device with respect to the first wireless network and the second wireless network.

15. The system as in claim 13, wherein the threshold information includes a first threshold value and a second threshold value, the first threshold value specifying a first threshold level of controlling the connectivity of the first mobile communication device with respect to the first wireless network and the second wireless network, the second threshold value specifying a second threshold level of controlling the connectivity of the first mobile communication device with respect to the first wireless network and the second wireless network.

16. The system as in claim 13, wherein the first threshold value indicates a first link quality level in which to control active session network transition of the first mobile communication device from the first wireless network to the second wireless network; and
wherein the second threshold value indicates a second link quality level in which to control active session network transition of the first mobile communication device from the second wireless network to the first wireless network.

17. The system as in claim 16, wherein the active session network transition of the first mobile communication device from the first wireless network to the second wireless network depends on a first link quality value and a second link quality value;
wherein the first link quality metric indicates a first wireless link value of the first mobile communication device receiving first wireless communications from the first wireless network, the first wireless link quality value measured by the first mobile communication device; and
wherein the second link quality value indicates a second wireless link quality of the first mobile communication device receiving second wireless communications from the second wireless network, the second wireless link quality value measured by the first mobile communication device.

18. The system as in claim 13, wherein the threshold information includes a first threshold level and a second threshold level, the first threshold level indicating a first link quality level in which to initiate network transitions from the first wireless network to the second wireless network, the second threshold level indicating a second link quality level in which to control active session network transitions from the second wireless network to the first wireless network.

19. The system as in claim 18, wherein the communication management hardware further operative to:
receive a first link quality value indicating a link quality of a first mobile communication device receiving first wireless communications from the first wireless network; and
compare the first link quality value to the first threshold level.

20. The system as in claim 19, wherein the communication management hardware is further operative to:
initiate an active session network transition of the first mobile communication device from the first wireless network to the second wireless network in response to detecting that the first link quality value is less than the first threshold level.

21. The system as in claim 19, wherein the communication management hardware further operative to:
initiate an active session network transition of the first mobile communication device from the second wireless network to the first wireless network in response to detecting that the first link quality value is greater than the second threshold level.

22. The system as in claim 19, wherein the communication management hardware is further operative to:
prevent an active session network transition of the first mobile communication device from the first wireless network to the second wireless network in response to detecting that the first link quality value is greater than the first threshold level.

23. The system as in claim 13, wherein the wireless link quality as indicated by the first link quality metrics are generated based on feedback from each respective mobile communication device of the first mobile communication devices.

24. The system as in claim 13, wherein the first link quality metrics include:
i) a wireless power level as measured by the respective mobile communication device receiving a first wireless signal from the first wireless network, and
ii) a signal-to-noise ratio as measured by the respective mobile communication device receiving the second wireless signal from the wireless network.

25. Computer-readable storage hardware having instructions stored thereon, the instructions, when carried out by computer processor hardware, cause the computer processor hardware to:
receive first link quality metrics indicating wireless link quality provided by first wireless base stations in a first wireless network to first mobile communication devices;
generate a first distribution function from the first link quality metrics; and
generate threshold information associated with the first distribution function, the threshold information used to control connectivity of a first mobile communication device with respect to the first wireless network and a second wireless network.

26. The method as in claim 1, wherein the first mobile communication device operates in the DSDS (Dual SIM Dual Standby) mode of transitioning between the first wireless network and the second wireless network, the transitioning controlled based on the first distribution function and the threshold information.

27. The system as in claim 13, wherein the first mobile communication device operates in the DSDS (Dual SIM Dual Standby) mode of transitioning between the first wireless network and the second wireless network, the transitioning controlled by the communication management hardware based on the first distribution function and the threshold information.
